(19) United States
(12) Patent Application Publication
(10) Pub. No.: US 2002/0184054 A1
(43) Pub. Date: Dec. 5, 2002

(54) Two-way practice management data integration

(76) Inventors: Robert Cox, Marietta, GA (US); Mjahid Alam Beg, Acworth, GA (US); James C. Davis, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/133,157

(22) Filed: Apr. 26, 2002

Related U.S. Application Data
(60) Provisional application No. 60/286,633, filed on Apr. 26, 2001.

(51) Int. Cl. G06F 17/60; G06F 15/16

(52) U.S. Cl. 705/2; 709/203

(57) ABSTRACT

The system provides true two integration of web provided data into a practice management system. The system builds a web site on a host system and transmits input data from the web site to a remote computer system. The input data is any information provided by a patient to the web site. Additionally, the host system receives display data from a remote computer system. Each practice or remote system provides the display data for its patients. The display data typically consists of patient account information. When a web site receives a request from a patient, the host system retrieves that individuals data for display on the web site.

### CROSS REFERENCE TO RELATED APPLICATIONS

This patent application claims priority to the U.S. Provisional Application serial No. 60/286,663 entitled “eLink Business Solution Architecture” filed on Apr. 26, 2001, which is incorporated in its entirety and made part hereof.

### REFERENCE TO COMPUTER PROGRAM LISTING SUBMITTED ON CD

This application incorporates by reference the XML listing appendix submitted on (1) CD-ROM entitled “XML Link Listing” in accordance with 37 C.F.R. §1.52(e). Pursuant to 37 C.F.R. §1.77(b)(4), the material on said CD-ROM is incorporated by reference herein, said material being identified as follows:

| Size in | Date of | |
|---|---|---|
| Bytes | Creation | File Name |
| 3,507 | Apr. 24, 2002 | LinkImportXML |
| 8,483 | Apr. 24, 2002 | LinkExportXML |

A portion of the disclosure of this patent document including said XML listing contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The invention relates generally to the field of network-based services and, more particularly, to the integration of web site data into an office practice management system.

### BACKGROUND ART

With the advent of service-centric computing, the Internet presents unparalleled opportunities for businesses. The Internet can enable the provision of numerous new services, streamline operations, and offer unprecedented convenience. Organizations that move online can realize significant economic and competitive gains. These advantages can include lowered costs, new customer relationships, branding opportunities, and the creation new lines of customer service. Yet, despite the promise of service-centric computing, major impediments have held back the enormous potential.

Clearly, the benefits offered by Internet technologies are enormous. These advantages can be particularly significant to service-centric industries such as the health care practice industry. In these industries, improving customer relationships and customer satisfaction is a constant concern. Ideally, web services technology will be able to improve customer satisfaction by providing service related assistance around the clock, both quickly and conveniently. Currently, ancillary activities, many of which do not directly relate to the provision of health care, require the assistance of office personnel. However, office personnel are usually unavailable after hours and are expensive to retain. Consequently, shifting the function provided by these individuals to web based solutions can increase customer satisfaction while simultaneously lowering costs.

If utilized, web based technology can manage aspects of health care practices more efficiently and provide greater flexibility for the patients. Services offered on-line can be available during any time of the day and provide immediate affirmation—without the need to be placed on hold for the availability of the proper office assistant. These activities include the ability to view or modify demographic data, review financial information or make account balance payments, request or reschedule appointments, complete pre-registration forms or provide updated insurance information, and make inquiries or simply send complaints. However, major impediments have prevented universal implementation of this potential.

Integration of web services within the health care practice industry has been hindered by the numerous differing practice management systems. Each practice management system has its own data format and differing database access. Furthermore, vendors can change their format or data formats can change with the adoption of a new practice management system. Consequently, directly accessing a databases has not been reliable. Additionally, it is prohibitively expensive for each practice to independently develop a web site that can seamlessly integrate their current practice management system.

Optimally, practice system data should be available for display on a web site and any data received from the web site should be easily integrated into the practice system data. Currently, web site building solutions exist that enable a practice to build and display custom information. Also, data transfer solutions exists which can translate data from one system to another. However, current technologies have yet to provide a comprehensive solution which incorporates web site building technologies seamlessly with data transfer technologies.

The difficulties associated with web site data integration has prevented health care industry from widespread adoption of two-way integration of web based technology. Various techniques have been tried to resolve this situation. One current web based solution includes the creation of a web site that includes data forms that can be completed on-line and sent via email to the health care practice. In spite of this advancement, the information provided in this manner is not currently not capable of being effectively parsed by commercial web browser parsers, and thus, hinders automatic integration into the practice management system. Consequently, these systems necessitate re-keying of data to integrate the data into the existing practice management system. Some practices have implemented web sites that can display current practice information. However, many practitioners do not want to waste time or resources creating and maintaining an updated web site. Nevertheless, current known health care practice management web based solutions have not successfully implemented true-two way integration.

While automated solutions can revolutionize the way one does business, web services solutions are needed that can alleviate the implications resulting from diverse systems. In order to gain widespread adoption, web service solution technology needs to be accessed by customers independent of hardware, operating systems, or even programming environment. Web services are needed to enable business to improve collaboration with customers and lower transaction costs. A system is needed that enhances customer services levels by utilization of web services. The system needs to protect current system investments and avoid any technology lock. A system is need that creates a comprehensive solution from the creation of a web site to true-two way data integration with the practice management system.

### DISCLOSURE OF THE INVENTION

The present invention provides true two integration of web provided data into a practice management system. This novel web services solution seamlessly incorporates web site building technology with data transfer technologies. The system provides a solution that is platform independent, and thus, can readily gain widespread adoption. In addition, the system also protects current technology investments and avoids any technology look. By utilizing web services, the system enhances customer service levels while lowering transaction costs. The invention creates a comprehensive solution from web site creation to two-way integration.

Generally speaking, in one embodiment, a web site is built on a host system, and the host system transmits the data inputted to the web site to a remote computer system. Additionally, the host system receives display data from the remote systems. The display data typically consists of patient account information. Each practice or remote system provides the display data for its patients. The data utilized in the system is generally formatted as character data stored in connection with metadata to create elements of a markup language. A web site associated with a particular practice can display the provided display information to its patients. This display data is stored on a storage device and is associated with the particular remote system that provided the data. When a web site receives a request from a patient, the host system retrieves that individuals data for display. In addition, the remote system can automatically update its primary record data based upon the input data.

An additional embodiment of the invention include the provision of a session key. The session key assures data consistency and data integrity by the enforcement of synchronization rules that prevent data overwrites. The session key remains valid for the duration of that particular session. The session key is generated from the login information provided by the practice management information.

Further embodiments include the practice management system providing patient access authorization before a patient can access the patient can log into a patient access unit associated with a web site. Upon the patient logging into the patient access unit, the patient is requested to change the patient's password. The new patient password is stored at a host system and is inaccessible to the practice management system.

### BRIEF DESCRIPTION OF THE DRAWINGS

Benefits and further features of the present invention will be apparent from a detailed description of preferred embodiment thereof taken in conjunction with the following drawings, wherein like elements are referred to with like reference numbers, and wherein:

FIG. 1 is a functional block diagram illustrating the operation of an exemplary web site integration system.

FIG. 2 is a functional block diagram illustrating an exemplary practice system architecture.

FIG. 3 is a functional block diagram illustrating an exemplary architecture of a client integration unit.

FIG. 4 is a functional block diagram illustrating an exemplary architecture of a server integration unit.

FIG. 5 is a functional block diagram illustrating an exemplary architecture of a web site unit.

FIG. 6 is a functional block diagram illustrating an exemplary architecture of a patient access unit.

FIG. 7 is a XML listing of an exemplary new account message.

FIG. 8 is a XML listing of an exemplary appointment reschedule request message.

FIG. 9 is an exemplary flow diagram of a web site integration process.

FIG. 10 is an exemplary flow diagram of a web site creation process.

FIG. 11 is an exemplary flow diagram of a web site update process.

FIG. 12 is an exemplary flow diagram of a transfer data process.

FIG. 13 is an exemplary screen shot of a practice management web site homepage.

FIG. 14 is an exemplary screen shot of a patient login web page.

FIG. 15 is an exemplary screen shot of a patient activity web page.

FIG. 16 is an exemplary screen shot of a patient account web page.

FIG. 17 is an exemplary screen shot of a patient appointment web page.

FIG. 18 is an exemplary screen shot of a detailed patient appointment web page.

FIG. 19 is an exemplary screen shot of a medical history web page.

FIG. 20 is an exemplary screen shot of a financial balance web page.

FIG. 21 is an exemplary screen shot of a contact request web page.

### BEST MODE

The present invention builds a customized web site that integrates with the practice management system. This system provides a cost effective solution for healthcare practices to offer web-based services utilizing true two-way data integration with the practice management system. The automated solution alleviates the implications that result from diverse systems. The incorporated web service solution technology provides access by customers independent of hardware, operating systems, or even programming environment. By utilizing Extensible Markup Language (XML) and related technologies, the system provides a platform independent solution. As a consequence, the web services solution will enable business to improve collaboration with customers and lower transaction costs. The system will enhance customer services levels by the utilization of web services. Additionally, this system protects current practice technology investments and avoids any technology lock. As discussed, the business solution provides full-cycle integration of patient data between a client-server practice management system.

The web services integration system provides a practice with the ability to transfer patient data securely between the practice web and the client-server practice management system. Additionally, the system can publish and make available patient data from a custom web site. Consequently, patients can view or modify information, make payments, request services or appointment while on-line. Additionally, prospective patients can complete pre-registration information at the web site thereby eliminating the need for the patient to visit the practice first. Furthermore, the system enables communication with patients more efficiently via the use of customized, personalized e-mail messaging. The system propagates the changes and requests made at the practice web site back to the practice. In addition, the system can transfer specific information to the practice management vendor. This data is seamlessly and transparently integrated with the practice management system.

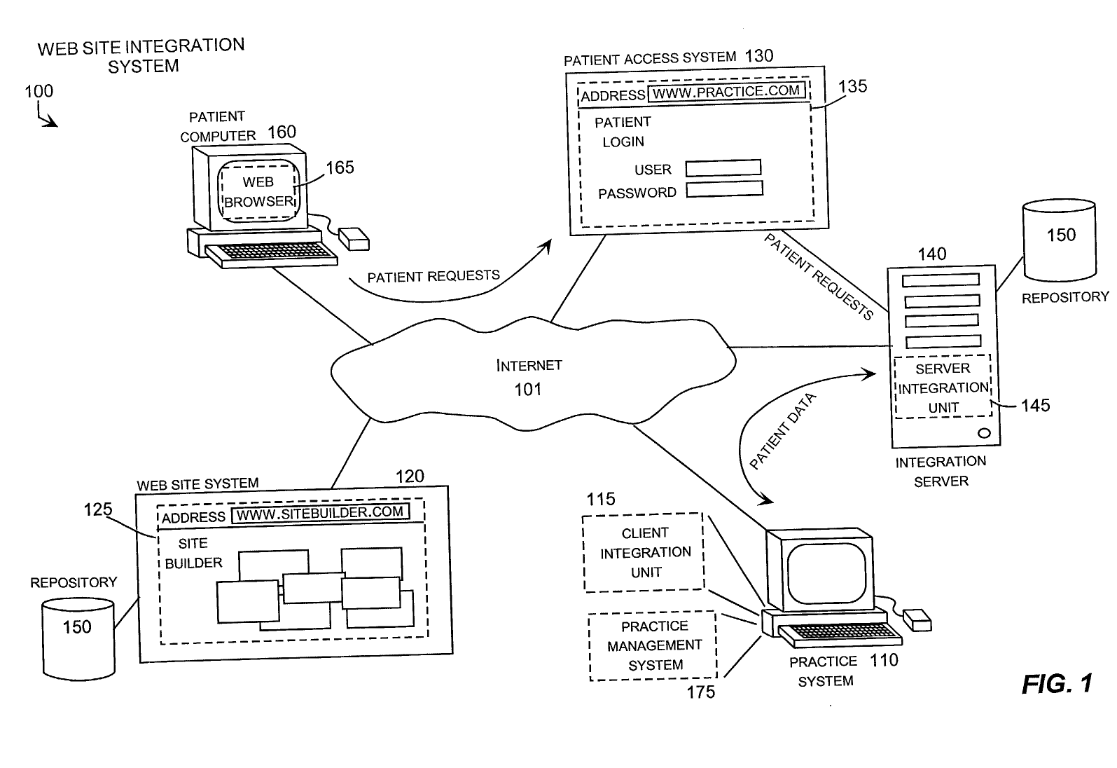

Turning to the figures, in which like numerals indicate like elements throughout the several figures, FIG. 1 provides an overview of a web services technology integration system. The system provides a comprehensive solution from the creation of a web site to true-two way data integration with a practice management system 175. In the exemplary web site integration system 100, the business solution is achieved by the integration of a suite of several custom software components. As illustrated, the main suite components include a site builder unit 125, a patient access unit 135, a client integration unit 115, and a server integration unit 145.

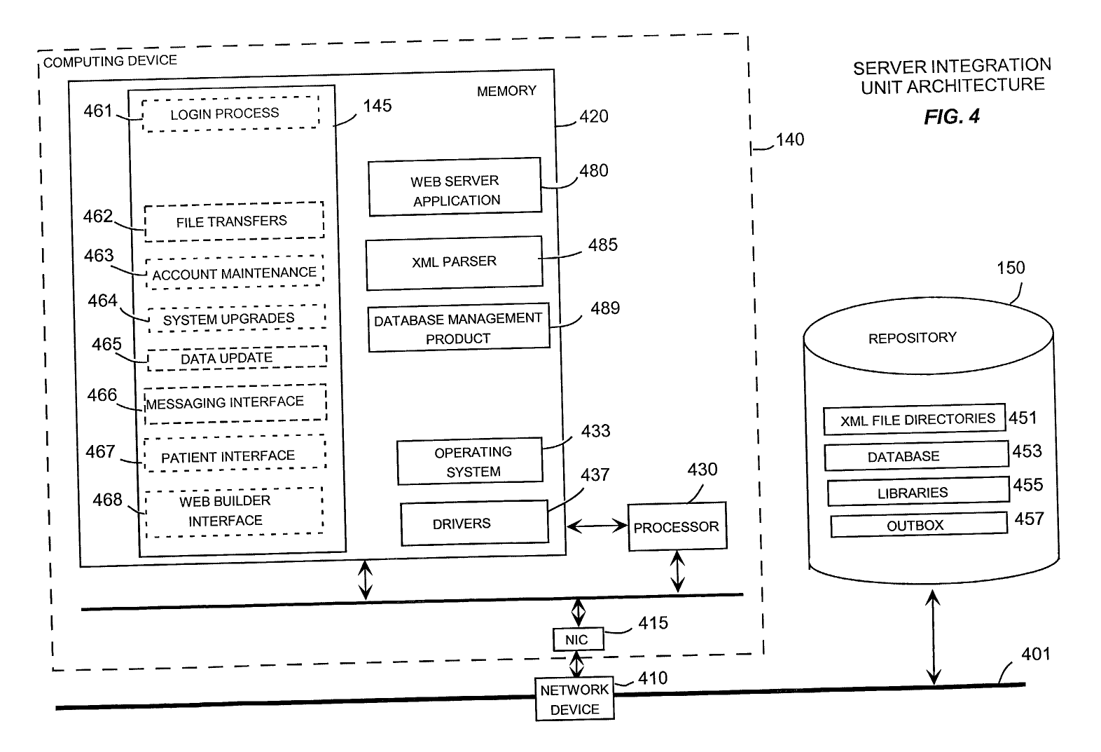

The web site system 120 includes a site builder unit 125. The site builder unit is discussed in greater detail in reference to FIG. 4. The site builder unit 125 creates custom, professionally designed web sites without requiring any web site design expertise. The application 125 resides on a hosted web server 120 accessible over the Internet 101. After logging into the site builder application 125, practice personnel are able to create or modify their web site at any time. The site builder unit 125 provides a menu driven wizard to create the web site. The web site provides a presence on the world wide web (WWW) and links to the web services suite.

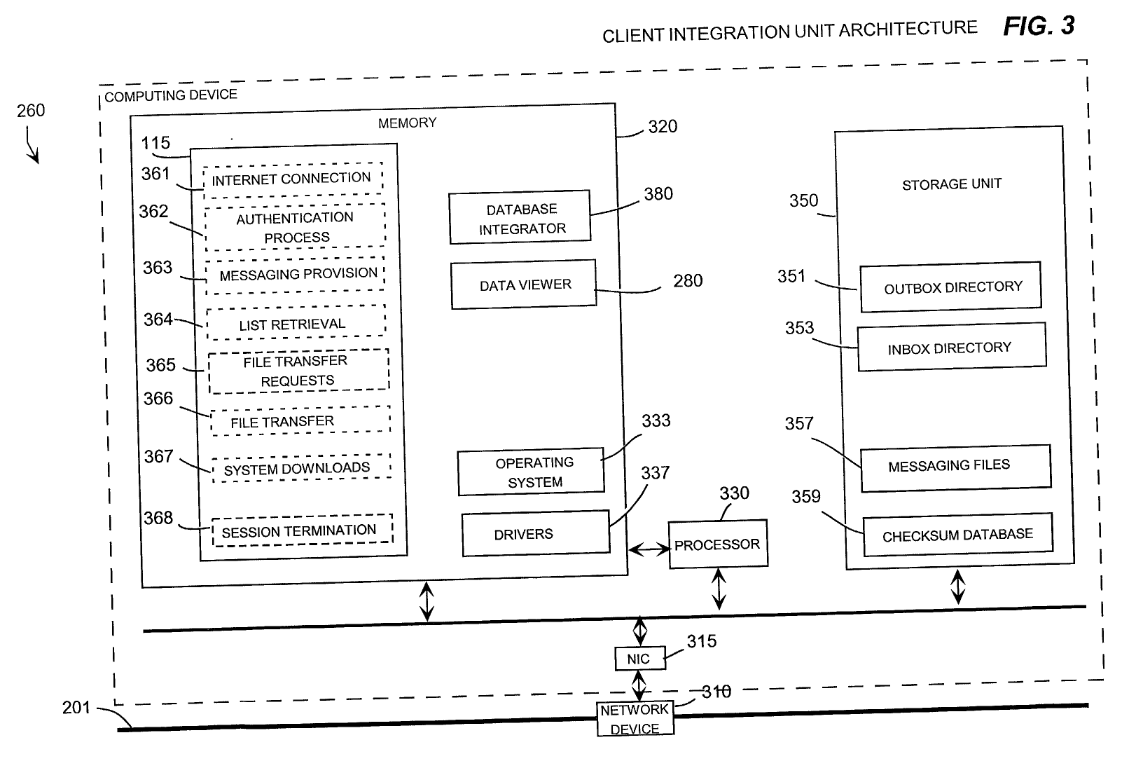

The site builder application 125 utilizes a repository 150 that stores practice authentication, billing, utilization, and other pertinent data. A more detailed discussion about the repository is described in reference to FIG. 3. Information about the about the practice is stored is stored in XML data files. The repository also contains a library of templates that define the look of the web site which suits the need of the practice and the target audience. The templates are stored in Extensible Stylesheet Language (XSL) based format. In the process of building the web site, the application 125 merges the XML data files with the XSL based presentation layer to create a fully integrated site. By separating the presentation function from the data, the site builder unit 125 enables a practice to change the content and the look of the site without the assistance of a web site designer.

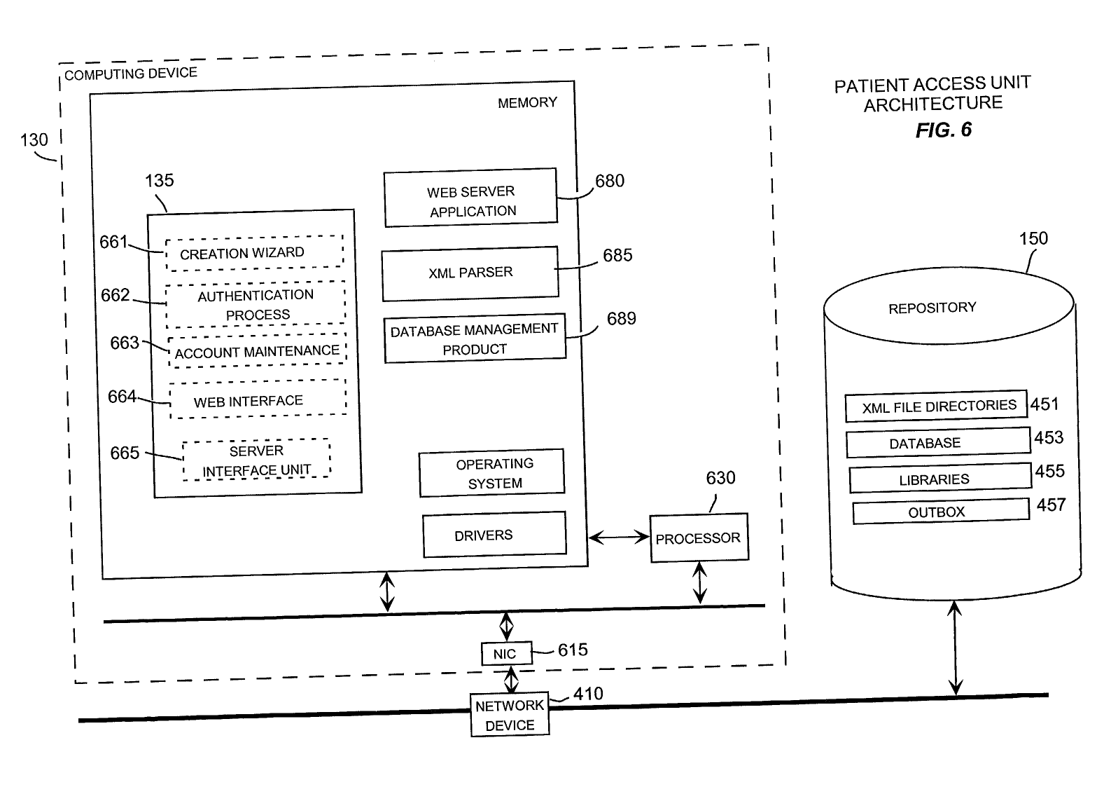

Once a web site is created, the site can be accessed by a web browser 165 on the world wide web. Basic content and general practice information is displayed. If a patient desires to access the web services, the patient access unit 135 is utilized. The patient access unit 135 is described in greater detail in reference to FIG. 6. The patient access unit 135 is closely integrated with the site builder unit 125 to enable seamless two-way integration of patient data with the practice web site. The patient access component 135 utilizes both practice specific and practice management specific XSL based templates to transparently extend the site builder 125 created practice web site.

The practice, through the client integration unit 115, can create patient accounts for any number of patients. By using a web browser 160 operated on a patient computer 160, a patient can access the web services. The patient can view or modify demographic information, review financial data or make payments, request or change appointments, complete pre-registration forms, and send questions or concerns they may have about the practice. The client integration unit 115 and the server integration unit 145 operate together to create these patient accounts and transfer the data stored on the repository 150.

The client integration unit 115 resides and executes at the practice system 110. The client unit 115 integrates with and extends the functionality of the practice management system 175. Because of the platform independent technology, the web services solution can be extended to virtually any practice management system 175.

Various processes, events, and operator interactions trigger file creations or modifications at the practice management system 175. These triggers include patient appointment activity, financial transactions, activities on a patient account, messaging actions, system errors, and the like. After a triggering event, the practice management system 175 can initiate client integration application 115 on a per file mode or batch mode as desired.

Once initiated, the client integration unit 115 connects to and establishes a connection with the server integration unit 145. Once connected to the integration server 140, the client integration unit 115 sends authentication information. The server integration unit 145 uses this information to verify the authenticity of the client 110 and to prevent multiple machines at any one practice from attempting simultaneous transfer of files to the server 140. Once authenticated, the client application 115 retrieves the files that are available for that practice on the integration server 140. All file transfers are done in compressed form in order to minimize transfer times and maximize efficiency.

Once all server files are received, the client application 115 initiates transfer of the files that are awaiting to be uploaded to the integration server 140. These files include patient data files, messaging files, and any system or support files. After file exchanges are completed, the client integration unit 115, also initiates, if necessary, a download of any application component. After all transfers, the client unit 115 logs out and disconnects any dial up communications that it may have initiated.

The server integration unit 145 is a custom application that resides on a hosted web server 140. The server application 145 utilizes efficient multithreaded architecture to provide fast response times and seamless concurrency. A detailed discussion of the server integration unit is presented in reference to FIG. 3. The server application 145 is responsible for communicating with multiple client applications 115 and transferring of data between the repository 150 and the clients practice management system 175. The server unit 145 also servers as a conduit to route messaging and system data that it receives from the client integration unit 115. The server application 145 also assures data consistency and data integrity by enforcing synchronization rules and preventing data overwrites.

The repository 150 is a secure container of practice, patient, messaging, and system data. The repository 150 is comprised of one or more database servers and multiple web data files. The database contains practice and patient authentication information and other pertinent data. Various components of the solution suite utilize the database in order to authenticate practices and patients, prepare billings, prepare reports, and other functions. The data files are based on the Extensible Markup Language (XML) standard. Consequently, the format is readily expandable allowing for virtually transparent and seamless updates and modifications. Additionally, the data can be maintained separate from the presentation. The web service solution components utilize this functionality by allowing unique, customized look for each practice web site.

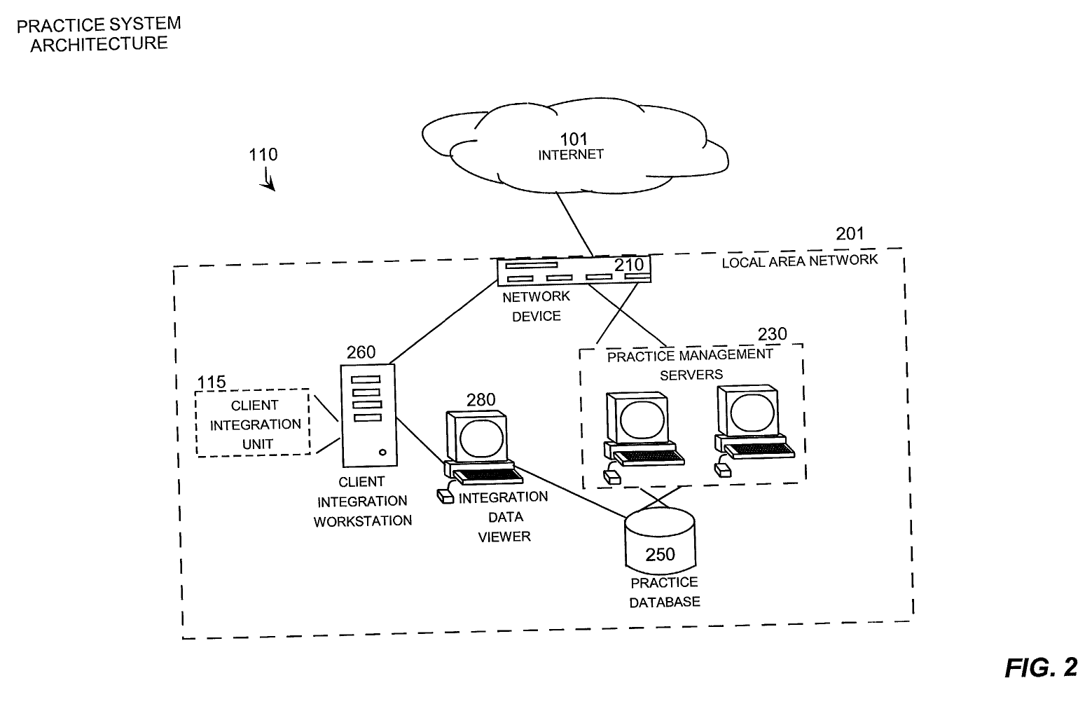

FIG. 2 and the subsequent figures provide illustrations for a discussion of a series of message formats, data structure diagrams, hardware and software architectures, process diagrams in the form of flow charts, and user interface screen shots that illustrate an exemplary embodiment of a system and corresponding methods for the disclosed web site integration system 100.

Discussed are logical hardware and software architecture of the system 100 constructed in accordance with an embodiment of the present invention. As will be understood in the art, the system is constructed utilizing Internet-enabled computer systems with computer programs designed to carry out the functions described herein. Although the disclosed embodiments are generally described in reference to Internet-accessible computers including the web site integration system 100, those skilled in the art will recognize that the present invention can be implemented in conjunction with other program modules for other types of computers.

The disclosed embodiment of the present invention is implemented in a distributed computing environment such as the Internet. In a distributed computer environment, program modules may be physically located in different local and remote memory storage devices. Execution of the program modules may occur locally in a stand-alone manner or remotely in a client/server manner. By way of illustration and not limitation, distributed computing environments include local area networks (LAN) of an office, enterprise-wide area networks (WAN), and the global Internet (wired or wireless connections). Accordingly, it will be understood that the terms computer, operating system, and application program include all types of computers and the program modules designed to be implemented by the computers.

The discussion of methods that follows, especially in the flow charts, is represented largely in terms of processes and symbolic representations of operations by conventional computer components, including a central processing unit (CPU), memory storage devices for the CPU, connected display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU, or remote server such as an Internet web site, and the maintenance of these signals within data structures reside in one or more of the local or remote memory storage devices. Such data structures impose a physical organization upon the collection of data stored within a memory storage device and represent specific electrical, optical, or magnetic elements. These symbolic representations are the means used by those skilled in the art of computer programming and computer construction to effectively convey teachings and discoveries to others skilled in the art.

For the purposes of this discussion, a process is understood to include a sequence of computer-executed steps leading to a concrete, useful, and tangible result, namely, the integration of web site and associated services with a practice management system.

These steps generally require manipulations of quantities or data strings such as patient names, passwords, financial information, insurance information, appointment schedules, demographic information, and other pertinent data. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, values, elements, symbols, characters, terms, numbers, points, records, objects, images, files or the like. It should be kept in mind, however, that these and similar terms should be associated with appropriate quantities for computer operations, and that these terms are merely conventional labels applied to quantities that exist within and during operation of the computer.

It should also be understood that manipulations within the computer are often referred to in terms such as displaying, deciding, storing, adding, comparing, moving, positioning, placing, and altering which are often associated with manual operations performed by a human operator. The operations described herein include machine operations performed in conjunction with various input provided by a human operator or user that interacts with the computer. In addition, it will be understood that the programs, processes, routines and methods described herein are not related or limited to any particular computer or apparatus, nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

With the foregoing in mind, the drawing figures starting with FIG. 2 illustrate various functions, processes, or routines carried out by an embodiment of the present invention in which the described system 100 carries out the functions connected with the flow charts and data maintenance. The functions or processes in these figures are carried out in the described embodiment of the present invention by software executing in computers associated with the patients, the practices, or a hosting entity. Depending upon the particular operation, the computers are connected for data communications via a network such as the Internet 101. It will also be understood that the processes and methods presented here may be arranged differently, or steps taken in a different order. In other words, some processes and methods may be deleted, repeated, re-ordered, combined, or blended to form similar processes and methods. Please note that other embodiments of the present invention may combine certain application components onto the same server.

Turning to FIG. 2, illustrated is an exemplary architecture of a practice system. Typically, a practice system 110 consists of a plurality of computing devices 230 interconnected by a local area network 201 such as known token ring or Ethernet technology. The local network 201 is connected to a global public network commonly referred to as the Internet 101 by a network device 210 such as router.

It will be obvious to those skilled in the art that the network device 210 can include other functions such as firewall technology, load balancing, and network address translation. A router is operative in the known manner to send and receive data packets, typically in the form of TCP/IP packets commonly used for Internet communications. Typically, the data packets typically pass through a firewall, which ensures the overall security in a known manner before being passed to the application servers 230. Network address translation (NAT) is the known translation of Internet Protocol (IP) address used within one network to a different IP address known within another network. A load balancer operates in known manner to balance the load from various communications amongst a plurality of computers or servers that are employed to construct the practice system 110.

The application servers 230 generally include a plurality of redundant similarly configured servers that are operative to implement the practice management system 175. The practice management system 175 is software designed to manage the administration functions of a practice. These functions include patient scheduling, financial accounting, recordation of patient information, and other functions. Numerous practice management systems 175 are available from numerous vendors and each can employ different data formats with differing database access. As illustrated, the application servers 230 incorporate the function of database servers, which are operative to store and retrieve practice information from the practice database 250.

As illustrated, a client integration workstation 260 is operative to execute the client integration unit 115. The client integration unit 115 is discussed in greater detail in reference to FIG. 3. The client integration unit 115 is one component of the web services suite discussed in reference to FIG. 1. The client integration workstation 260 is coupled to an integration data viewer 280. The integration data viewer 280 is operable to exhibit data provided by the server integration unit 145 discussed in reference to FIG. 1. The new data provided can be displayed alongside with the current data stored by the practice system 110. As discussed in reference to FIG. 1, the data provided from the server integration unit 145 is received from the patient access system 130. The new data can be manually entered into the practice management system 175 or a data translation package using known programming technology can automatically update the data stored in the practice database 250 upon acceptance.

Turning to FIG. 3, illustrated is an exemplary architecture of a client integration workstation 260. The workstation 260 is connected to the practice local area network 201 in a known manner through a network device 310 such as a token ring or Ethernet hub. A network interface card (NIC) 315 couples the workstation 260 to the LAN 201. A NIC 315 allows network interfacing and handles commands sent from the workstation 260. Drivers 337 specifically adapted for the particular NIC 315 enable the network traffic data to be exchanged with the processor 330. Other drivers 337 are utilized to interface or communicate with other devices including peripherals. These peripherals include keyboards, monitors, printers, storage devices, and other input/output devices. As one skilled in the art will appreciate, such drivers are typically packaged with the system. As discussed in reference to FIG. 2, the practice local area network 201 is connected to the Internet 101 for global networking.

The operating system 333 for the workstation 260 preferably needs to be compatible with the workstation hardware. One operating system 33 that can be utilized is the operating system referred to as MICROSOFT'S WINDOWS NT. One skilled in the art will appreciate that other operating systems may be readily substituted. As is known to those skilled in the art, the operating system of a computer controls the operation of the processor 330. The processor 330 interfaces with the memory 320 to execute programs. Preferably, the workstation will have sufficient memory to run any loaded application.

The client integration workstation 260 is operable to execute the custom software of the client integration unit 115. An overview of the client integration unit115 interaction with other components of the web site integration system 100 is presented in reference to FIG. 1. In a known manner, the client integration unit 115 is loaded into the workstation memory 320, and a processor 330 executes the client integration software 115. The client integration software 115 is operable to perform the client integration application functions 361-368.

Various processes, events, and operator interactions trigger file creations or modifications at the practice management system 175. These triggers can include patient appointment activity, financial transactions, activities on a patient account, messaging actions, system errors, and the like. The created files or file modifications are stored in a outbox directory 351 on a storage unit 350 associated with the workstation 260. As illustrated, the files can be stored in a storage device internal to the workstation. Alternatively, those skilled in the art will recognize that a file storage system can be external and connected by the practice's LAN 201. The practice management system 175 can initiate client integration application 115 on a per file mode or batch mode as desired.

Once initiated, the client integration unit 115 performs an Internet connection function 361. The Internet connection function 361 detects the availability and state of Internet connectivity at the local machine, and if necessary, dials and connects to the Internet 199. Additionally, the connection function 361 establishes a connection with the server integration unit 145 using Secure Socket Layer (SSL) technology. The connection is made utilizing the known Hypertext Transfer Protocol over Secure Socket Layer (HTTPS) protocol.

Once connected to the integration server 140, the authentication process function 362 sends authentication information to the server integration unit 145. The authentication information can include the user name, password, current client integration unit version, and a globally unique identifier (GUID). This information is used to verify authenticity of the client integration unit 115 and prevent multiple machines at any one practice from attempting to simultaneously transfer files to the integration server 140. The synchronization rules associated with a session is discussed in further detail in reference to FIG. 4.

Once authenticated, the messaging function 363 provides any messaging requests and transmits any system messages. The practice can design multiple web cards for messaging purposes. The messaging component is discussed in greater detail in reference to FIG. 4. The multiple web cards use Hypertext Markup Language (HTML) messaging templates, which include predefined text and images to create in a known manner HTML emails. HTML utilizes tags to mark elements, such as text and graphics, in a document to indicate how a browser should display these elements and respond to user actions such as the activation of a link. These cards can be used for season greeting cards, birthday cards, appointment reminders, and other messaging functions.

The practice system 110 downloads a list of cards previously defined on the web site. The practice can specify a list of patients to associate with each defined card. This messaging request is provided to the integration server unit 145. Additionally, the messaging function 363 transmits system application errors, diagnosis data, and potential issues to the server integration unit 145. As illustrated, the messaging files can be stored in a messaging directory 357 on a storage unit 350 associated with the workstation 260. These system messages are routed to the support personnel at the practice system vendor.

After performance of the messaging function 363, the client integration unit 115 retrieves a list of files that are available for this practice on the integration server 140. If available, the list retrieval function 364 also retrieves a list and location of newer version of the client integration software 115 or other components.

The file transfer request function 365 initiates a request and receives each file for this practice that is stored on the integration server 140 for downloading. Each file is individually downloaded in compressed form. As illustrated, the downloaded files can be stored in an inbox directory 353 on a storage unit 350 associated with the workstation 260. The file transfer request function 365 maintains a record of the files transfers that have been completed. If the session is unexpectedly terminated, the transfer can begin with the next file.

An example of a typical XML that is downloaded to the client integration unit 115 is provided on the attached XML listing appendix labeled “LinkImportXML.” A file is provided for downloading whenever a patient interacts with the practice web site and provides information to the patient access unit 135. For example, a patient may request to reschedule an appointment, change demographic information, update medical status, or simply request a copy of the last statement. As illustrated, the XML file can include numerous elements for account information with appropriate action codes, insurance information, patient information, appoint reschedule information, medical history information, contact requests, and other information.

Once all server files are received, the client integration unit 115 initiates transfer of files queued to be uploaded to the integration server 140. The practice management system 175 creates files to be uploaded to the integration server 140. These files can be created or modified upon a triggering event. Various processes, events, and operator interactions trigger file creations or modifications at the practice management system 175. These triggers include patient appointment activity, financial transactions, activities on a patient account, messaging actions, system errors, and the like. As illustrated, these files can be stored in an outbox directory 351 stored in a storage unit 350 associated with the workstation 260. The practice management system 175 can initiate client integration application 115 on a per file mode. Alternatively, the practice management system 175 can initiate client integration application on a batch mode, as desired.

The file transfer function 366 loads the files stored in the outbox directory 351. Instead of creating and storing a patient file for only those newly created or modified records, some practice management systems 175 simply create a patient file for each patient in the practice database 250. Therefore, the file transfer function 366 performs a checksum of each file to determine if that file has changed since the last transfer. The client integration unit 115 determines from the calculated checksum those files that have changed data from the last time the file was encountered. The checksum values can be stored in a checksum database 359 on a storage device 350 associated with the workstation 260. If it is determined that the most current information is already exists on the integration server 140, the file is deleted from the outbox directory 351 and no file export for that file is performed. If the file has changed, the file is sent and the new checksum in stored in the checksum database 359. After transmitting the file, the file is deleted from the outbox directory 351. The file transfer function 367 deletes the files from the storage unit 350 in order to increase the security of the information and reduce storage requirements.

An example of a typical XML that is uploaded to the server integration unit 145 is provided on the attached XML listing appendix labeled “LinkExportXML.” As illustrated, the XML file can include numerous elements for account information with appropriate action codes, insurance information, payment information, patient information, appoint information, medical history information, and other information.

After the exchange of files are completed, the system download function 367, receives any new application component. The system download function 367 initiates an auto-update operation to update to the current version of any component. After all transfers are completed, the system termination function 368 logouts of the server integration unit 145 and disconnects any initiated Internet connections.

After the session is terminated, the practice updates the records of the practice management system 175. A data viewer 280 can display the current data side by side with the existing data for each patient. The XML data is displayed using known Extensible Stylesheet Language (XSL) technology. Extensible Stylesheet Language (XSL) is an XML based language to create stylesheets. A stylesheet defines the layout of an output document and where to retrieve the data within an input document.

The changes to the existing files can be manually keyed if the changes are acceptable. Alternatively, custom software can automatically implement the changes into the database upon acceptance.

Turning to FIG. 4, illustrated is an exemplary architecture of an integration server 140. The integration server 140 is connected to the host local area network 401 in a known manner through a network device 410 such as a token ring, Ethernet hub, or similar devices. A network interface card (NIC) 415 couples the workstation to the host's LAN 401. A NIC 415 allows network interfacing and handles commands sent from the server 140. Drivers 437 specifically adapted for the particular NIC 415 enable the network traffic data to be exchanged with the processor 430. Other drivers 437 are utilized to interface or communicate with other devices including peripherals. These peripherals include keyboards, monitors, printers, storage devices, and other input/output devices. As one skilled in the art will appreciate, such drivers are typically packaged with the system. The host local area network 401 is connected to the Internet 199 for global networking.

The operating system 433 for the integration server 140 preferably needs to be compatible with the workstation hardware. One operating system 433 that can be utilized is the operating system referred to as MICROSOFT'S WINDOWS NT. One skilled in the art will appreciate that other operating systems may be readily substituted. As is known to those skilled in the art, the operating system of a computer controls the operation of the processor 430. The processor 430 interfaces with the memory 420 to execute programs. Preferably, the server 140 will have sufficient memory to run any loaded application.

The integration server 140 is operable to execute the custom software of the server integration unit 145. An overview of the server integration unit 145 interactions with other components of the web site integration system 100 is presented in reference to FIG. 1. In a known manner, the server integration unit 145 is loaded into the workstation memory 420, and a processor 4330 executes the server integration software 145. The server integration software 145 is operable to perform the server integration application functions 461-468.

As illustrated, the integration server 140 is operating as a hosted web server accessible over the Internet 199 utilizing a web server application 480 such as MICROSOFT'S INFORMATION INTERNET SERVER. In the exemplary presentment, the web server application 480 can be operable to pass a web request to an application program 145 utilizing the known common gateway interface (CGI) or can utilize Internet Sever Application Interface (ISAPI). In a known manner, an XML parser 485 can load the XML files stored by practice directories 451 in an associated repository 150. The XML parser can be incorporated as part of the web server application 480 as per MICROSOFT'S XML PARSER.

The server integration unit 145 interfaces with the other components of the web site integration suite. The server integration application 145 utilizes efficient multithreaded architecture to provide fast response times and seamless concurrency. The server application 145 communicates with multiple client integration applications 115 and transfers data between the repository 150 and the client systems 110.

The server integration unit 145 also is operable to route messaging and system data received from the client systems 110. The messaging interface function 466 processes messaging request from the client systems 110. The messaging requests are described in reference to FIG. 3. The messaging function 466 is operable to generate in a known manner patient e-mail or postal mail correspondences. Patient e-mail can be automatically routed using an e-mail address contained in the XML file for a patient. The XML parser 485 can locate the particular XML file and retrieve the stored e-mail address. Additionally, system message such as application errors, diagnosis data, potential issue information, and the like can be routed by known technology to the appropriate vendor support personnel.

The login process function 461 assures data consistency and data integrity by the enforcement of synchronization rules that prevent data overwrites. The login process function 461 has an authentication process that utilizes the practice system user identification and password. Each time a client system 110 logs on to the integration server 140, the server integration unit 145 generates and transfers a session key. The session key remains valid for the duration of that particular session. The session key is used to uniquely identify each client system and session combination.

The login process function 461 encrypts the user identification and creates hash value for the session key. This encrypted hash value is transferred to the client system. In all subsequent communications, the client system 110 includes this session key in subsequent HTTP headers that are transmitted. The server integration unit 145 will reject subsequent transmissions that do not include the appropriate session key in the HTTP header. The application of encryption key technology—in addition to the security provided by SSL technology—dramatically reduces security vulnerability of the integration server 140.

The practice account information is stored in a database 153 associated with the integration server 140. As illustrated, the database can be maintained by a database management product 489 such as a commercially available structured query language (SQL) system. The database 153 maintains practice account information and the patient login information. The practice integration unit 145 creates a new account identifier for each new patient, and the account information is transferred as a patient file that has an XML tag indicating the new account status.

The account maintenance function 463 has protocols to force a change of the password upon the patient login into the system. As a result, the practice system 110 does not maintain patient password records. Some of the account data is parsed out of the received data files and updated in the database 153 because a database can perform quick data inquiries. The complete XML files are then stored in appropriate directory 151 for that practice system 110 in the repository 150.

After performance of the login process function 461, the server integration unit transmits a list of files that are available for this practice on the integration server 140. The file transfer function 462 responds to requests and transmits each file that is stored on the integration server 140 for downloading. Each file is individually downloaded in compressed form. As illustrated, the files to be downloaded can be stored in an outbox directory 157 on a storage unit 150 associated with the workstation.

An example of a typical XML that is downloaded to the client integration unit 115 is provided on the attached XML listing appendix labeled “LinkImportXML.” A file is provided for downloading whenever a patient interacts with the practice web site and provides information to the patient access unit 135. For example, a patient may request to reschedule an appointment, change demographic information, update medical status, or simply request a copy of the last statement. As illustrated, the XML file can include numerous elements for account information with appropriate action codes, insurance information, patient information, appoint reschedule information, medical history information, contact requests, and other information.

Once all server files for that practice system 110 has been downloaded, the client integration unit 145 initiates transfer of files queued to be uploaded to the integration server 140. An example of a typical XML that is uploaded to the server integration unit 145 is provided on the attached XML listing appendix labeled “LinkExportXML.” As illustrated, the XML file can include numerous elements for account information with appropriate action codes, insurance information, payment information, patient information, appoint information, medical history information, and other information. After the exchange of files are completed, the server integration unit 145 upon receiving the request from the client system 100, downloads any new application component.

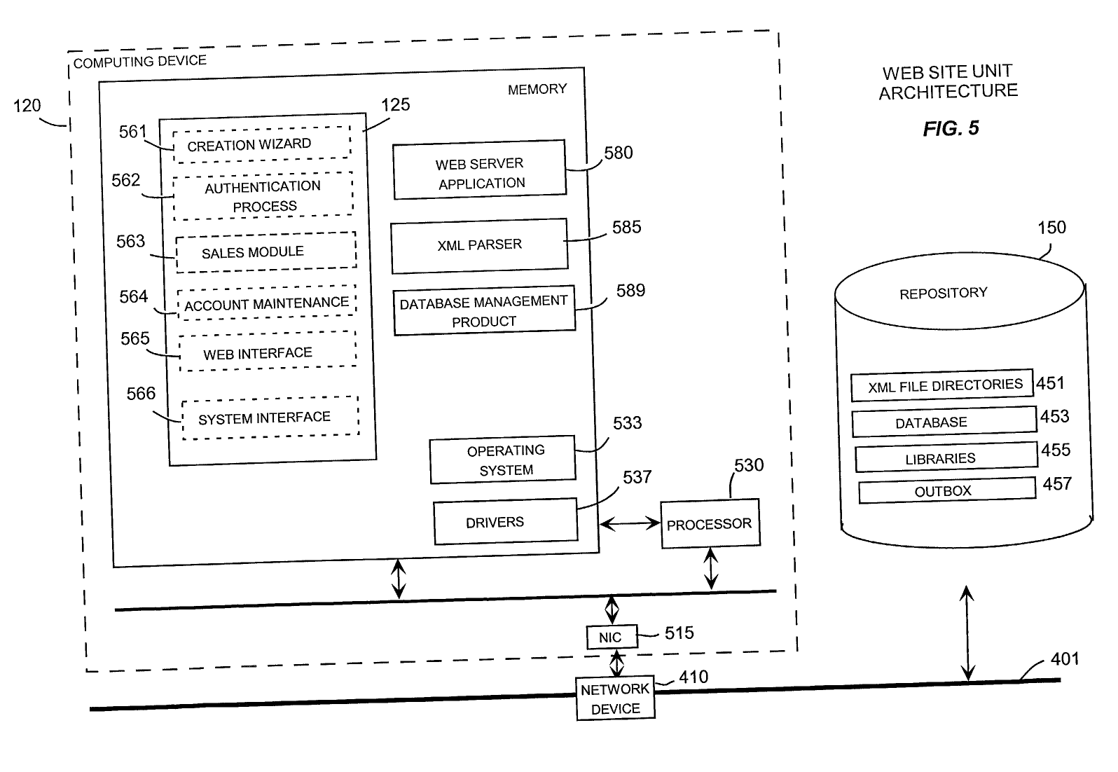

As discussed, some of the data is parsed out of the received data files and updated in a database 453 because a database can be indexed and perform quick data inquiries. The repository 150 also has a library 455 that stores templates for the creation of web sites. The templates for the web site creation are discussed in greater detail in reference to FIG. 5.

Turning to FIG. 5, illustrated is an exemplary architecture in accordance of one embodiment of a web site system 120. The web site system 120 is connected to the host local area network 401 in a known manner through a network device 410 such as a token ring, Ethernet hub, or similar devices. A network interface card (NIC) 515 couples the web site server 120 to the LAN 401. A NIC 515 allows network interfacing and handles commands sent from the web site system 120. Drivers 537 specifically adapted for the particular NIC 515 enable the network traffic data to be exchanged with the processor 530. Other drivers 537 are utilized to interface or communicate with other devices including peripherals. These peripherals include keyboards, monitors, printers, storage devices, and other input/output devices. As one skilled in the art will appreciate, such drivers are typically packaged with the system. As discussed in reference to FIG. 4, the host local area network 401 is connected to the Internet 101 for global networking.

The operating system 533 for the web site system preferably needs to be compatible with the system hardware. One operating system 533 that can be utilized is the operating system referred to as MICROSOFT'S WINDOWS NT. One skilled in the art will appreciate that other operating systems may be readily substituted. As is known to those skilled in the art, the operating system of a computer controls the operation of the processor 530. The processor 530 interfaces with the memory 520 to execute programs. Preferably, the web site system 120 will have sufficient megabytes to any loaded application.

The web site system 120 is operable to execute the custom software of the site builder 125. An overview of the site builder 125 interactions with other components of the web site integration system 100 is presented in reference to FIG. 1. In a known manner, the web site builder unit 125 is loaded into memory 520, and a processor 5330 executes the software 125. The site builder software 125 is operable to perform the application functions 561-566.

As illustrated, the web builder 125 is operating as a hosted web server accessible over the Internet 101 utilizing a web server application 580 as MICROSOFT'S INFORMATION INTERNET SERVER. In the exemplary presentment, the web server application 580 can be operable to pass a web request to an application program 145 utilizing the known common gateway interface (CGI) or can utilize Internet Sever Application Interface (ISAPI). The web interface function 565 in a known manner responds to requests that utilize the known Hypertext Transfer Protocol over Secure Socket Layer (HTTPS) protocol.

The web builder unit 145 also is operable to build custom web sites for a practice and build the back integration with the practice management system 110. The creation wizard function 561 requests practice specific information about the practice and the associated health care practitioners. The practice can supply custom graphics for the web site. These graphics can include pictures of the doctors, staff, satisfied customers, the site, and other content desired to be displayed. The practice can supply the content or choose preloaded content.

The authentication process function 562 utilizes user identification and password technology to authenticate the practice. The account maintenance function 564 stores the account information in a database 453 associated with system 120. As illustrated, the database can be maintained by a database management product 589 such as a commercially available structured query language (SQL) system.

Upon authentication, the web site can be rebuilt at any time changing the look or content. In a known manner, an XML parser 585 can load XML stylesheets stored in the libraries 455 on an associated repository 150. A stylesheet defines the layout of an output document and where to retrieve the data within an input document. The XML parser can be incorporated as part of the web server application 480 as per MICROSOFT'S XML PARSER.

The system interface function 566 builds the back end infrastructure to link and communicate with the web site integration system 100. The back integration does not change upon the redesign of the web site by the practice. The site builder unit 125 utilizes the repository 150 to store practice authentication, billing, utilization and other pertinent data. Information about the practice is stored in XML data files. Users can choose from a library 455 of templates to define the look of the web site that suits the needs of the practice. To build the actual practice web site, the site builder application merges XML data files with XSL based presentation layer. Separating the presentation from the data, site builder unit 125 allows a practice to change content of the site as often as desired.

The web site can be created with a sales module. The sales module function 563 incorporates into the web site the ability for a practice to offer items for sale. The data associated with the sale items are stored in XML files in a directory 451 associated with the practice. Stylesheets can present the sale data to a viewer in a known manner. Data sales information can be stored in the outbox 457 for transmission to the practice system as discussed in reference to FIG. 4.

Turning to FIG. 6, illustrated is an exemplary architecture in accordance of one embodiment of a patient access system 130. The patent access system 130 is connected to the host local area network 401 in a known manner through a network device 410 such as a token ring, Ethernet hub, or similar devices. A network interface card (NIC) 615 couples the patient access server 130 to the LAN 401. A NIC 615 allows network interfacing and handles commands sent from the patient access system 130. Drivers 637 specifically adapted for the particular NIC 615 enable the network traffic data to be exchanged with the processor 630. Other drivers 637 are utilized to interface or communicate with other devices including peripherals. These peripherals include keyboards, monitors, printers, storage devices, and other input/output devices. As one skilled in the art will appreciate, such drivers are typically packaged with the system. As discussed in reference to FIG. 4, the host local area network 401 is connected to the Internet 101 for global networking.

The operating system 633 for the patient access site system preferably needs to be compatible with the system hardware. One operating system 633 that can be utilized is the operating system referred to as MICROSOFT'S WINDOWS NT. One skilled in the art will appreciate that other operating systems may be readily substituted. As is known to those skilled in the art, the operating system of a computer controls the operation of the processor 630. The processor 630 interfaces with the memory 620 to execute programs. Preferably, the patient access system 130 will have sufficient megabytes to any loaded application.

The patient access system 130 is operable to execute the custom software of the patient access unit 135. An overview of the patient access unit 135 interaction with other components of the web site integration system 100 is presented in reference to FIG. 1. In a known manner, the patient access unit system 135 is loaded into memory 620, and a processor 630 executes the software 135. The patient access software 135 is operable to perform the application functions 661-665.

As illustrated, the patient access unit 135 is operating as a hosted web server accessible over the Internet 199 utilizing a web server application 680 as MICROSOFT'S INFORMATION INTERNET SERVER. In the exemplary presentment, the web server application 680 can be operable to pass a web request to an application program 135 utilizing the known common gateway interface (CGI) or can utilize Internet Sever Application Interface (ISAPI). In a known manner, an XML parser 485 can load the XML files stored by practice directories 451 in an associated repository 150. The XML parser 685 can be incorporated as part of the web server application 680 as per MICROSOFT'S XML PARSER.

Access to the patient access system 130 is controlled by the authgentication process function 662. The authentication function 662 requires a valid username and password to access the system 130. The patient login information is stored in a database 453 associated with the patient access server 130. As illustrated, the database can be maintained by a database management product 689 such as a commercially available structured query language (SQL) system. As discussed in reference to FIG. 3, the practice integration unit 145 creates a new account identifier for each new patient, and the account information is transferred as a patient file that has an XML tag indicating the new account status. The account maintenance function 663 has protocols to force a change of the password upon the patient login into the system 130. As a result, the practice system 110 does not maintain patient password records. Some of the account data is parsed out of received data files and updated in the database 153 because a database can perform quick data inquiries. The complete patient XML files are then stored in appropriate directory 151 for that practice system 110 in the repository 150.

The patient access unit 135 is operable to integrate patient data with the practice web site. The web interface function 664 utilizes both practice specific and practice management specific XSL based templates to transparently extend the practice web site created by the site builder unit 135.

As discussed in reference FIG. 4, the practice system 110 is able to create patient accounts for any number of patients. As previously discussed, the client integration unit 115 and serve integration unit 145 transfer the patient data, which is stored in the repository 150. The XML parser 685 is operable to retrieve a patient data stored in the practice directory.

Consequently, patients through the patient access unit 135 can view and modify demographic information, review financial and insurance information, make payments, request appointments, and send questions or concerns. Prospective patients can perform a limited subset of actions without required to acquire a username and password. Consequently, a new patient can request services from the practice prior to the first practice visit. These services include completion of registration information, request appointments, and addressing any specific concerns.

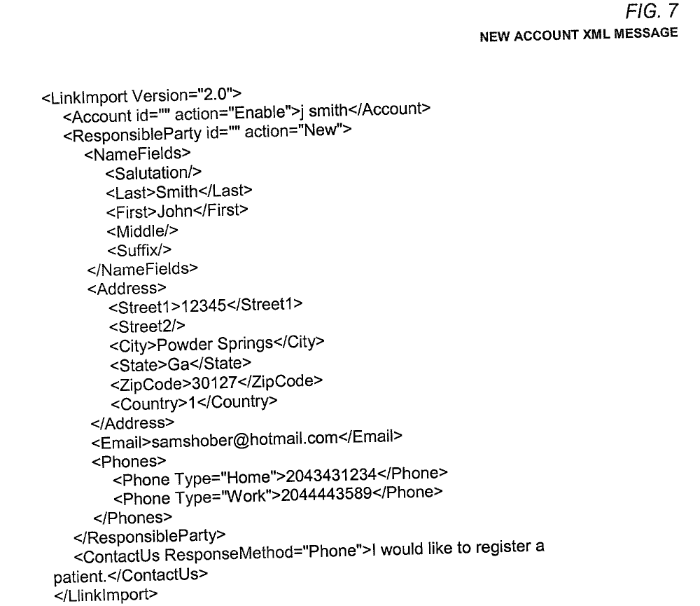

Turning to FIG. 7, illustrated in an exemplary new account XML message. As discussed in reference to FIG. 6, a new patient may desire to register as a new patient with a practice. On a new patient request, only basic information needs to be captured. This information is sufficient for office personnel to contact the individual. Complete account information may collected at a later time. As illustrated, the XML listing has elements for name and contact information. The account id field will be empty and the account action code will be set to “enabled.”

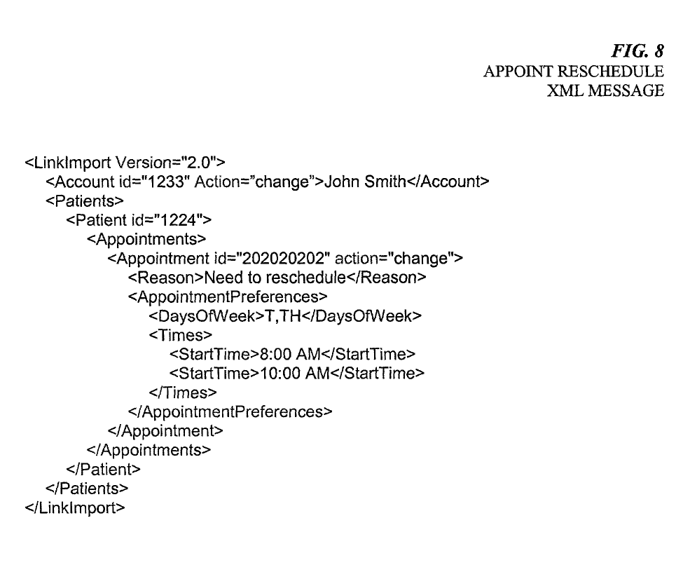

Turning to FIG. 8, illustrated in an exemplary appointment reschedule XML message. As discussed in reference to FIG. 6, a new patient may desire to reschedule an appointment. On an appointment reschedule request, only basic information needs to be captured. This information is sufficient for office personnel to reschedule the individual. As illustrated, the XML listing has elements for patient identification and reschedule information. The account id field can identify the patient and the account action code will be set to “change.” In the example, a patient with an identification of 1234 needs to reschedule an appointment with an id of 202020202, preferably on Tuesday or Thursday in the morning hours.

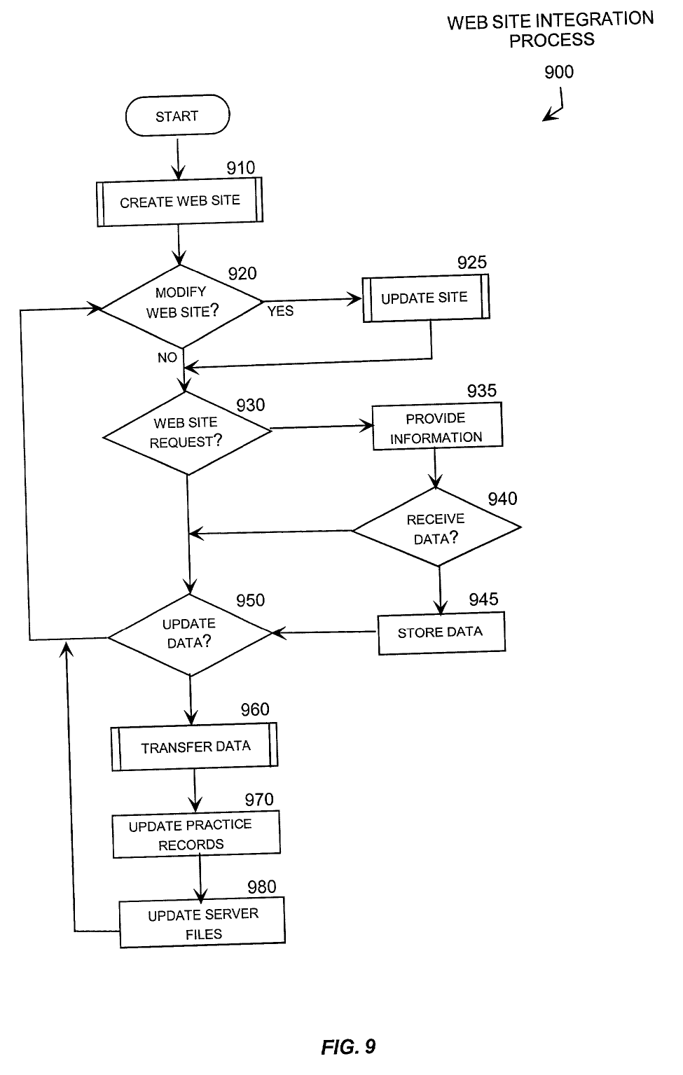

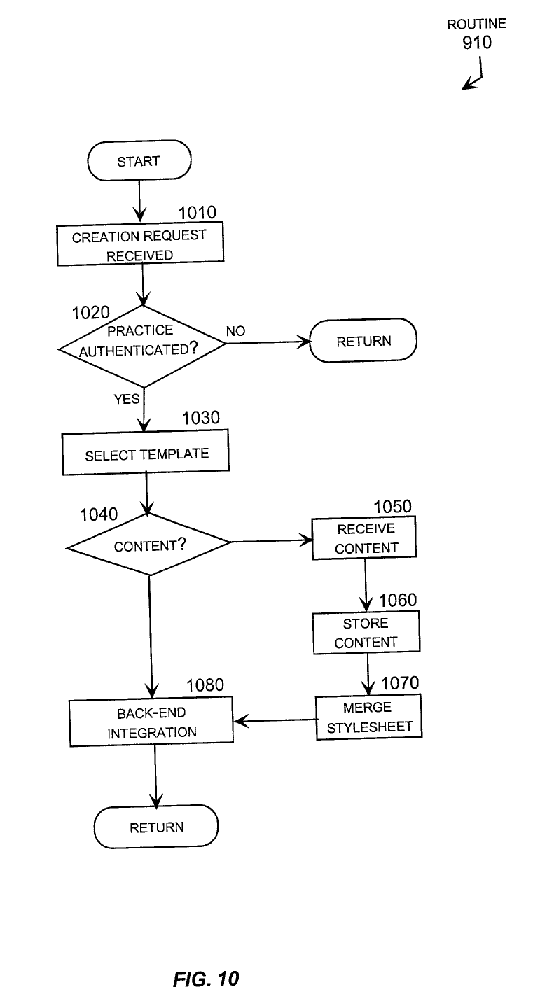

Turning now to FIG. 9, illustrated is an exemplary flow diagram providing the processes to be performed by the web site integration system 100. The main process 900 is initiated by a practice system 110 accessing web site system 120. In routine 910, the practice system 110 utilizes the site builder unit 125 to build a custom web site. Routine 910 is discussed in greater detail in reference to FIG. 10.

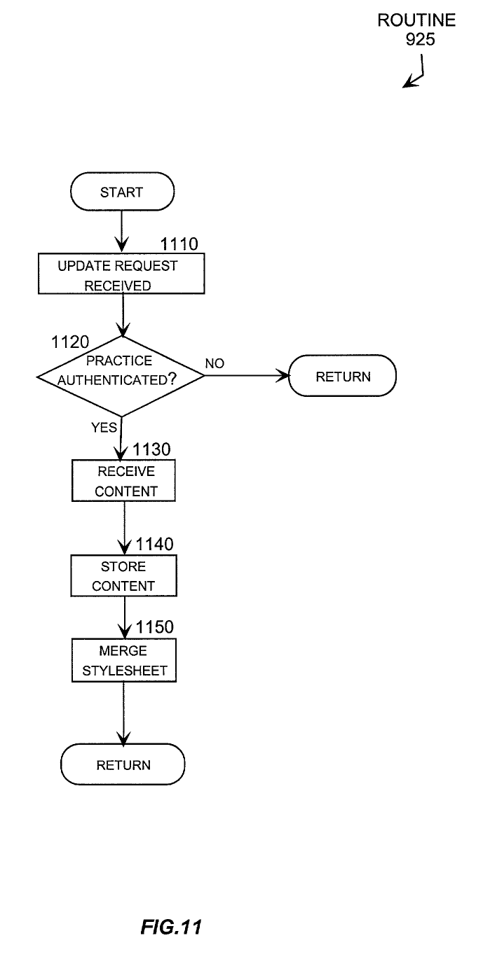

Routine 910 is followed by step 920, in which the web site system 120 determines if modifications to the practice web site are requested. If modifications are requested, the Yes branch of step 920 is followed to routine 925, in which the web site is updated. Routine 925 is described in greater detail in reference to FIG. 11. Routine 925 is followed by step 930, in which the web site system 120 determines is a web site request has been received. If modifications are not currently requested, the No branch of step 920 is followed to step 930.

If a web site request has been received, the Yes branch of step 930 is followed to step 935, in which the web site system 120 provides the practice web site. In step 925, the XML parser 685 searches the directories 451 to locate the particular practice system 110. The XML parser 685 identifies the particular patient and loads that XML file. The XML parser 685 parses the file to retrieve the information requested and provides that information for display. If a web site request has not been received, the No branch of step 930 is followed to step 950, in which the client integration unit 115 determines whether to update data.

Routine 935 is followed by step 940, in which the web site system 120 determines if data is to provided to the web site system 120. If data is not to be provided, the No branch of step 940 is followed to step 950, in which the client integration unit 115 determines whether to update data. If data is to be provided, the Yes branch of step 940 is followed to step 945. In step 945, the data entered into web site is stored in XML files in an outbox directory associated with the particular practice system. An XML parser can load and manipulate the XML files. Step 945 is followed by step 950.

In step 950, the client integration unit 115 determines whether to update data. Various processes, events, and operator interactions trigger file creations or modifications at the practice management system 175. These triggers include patient appointment activity, financial transactions, activities on a patient account, messaging actions, system errors, and the like. The practice management system 175 can initiate client integration application 115 on a per file mode or batch mode as desired. Typically, batch mode initiates the client integration unit 115 at predetermined set time.

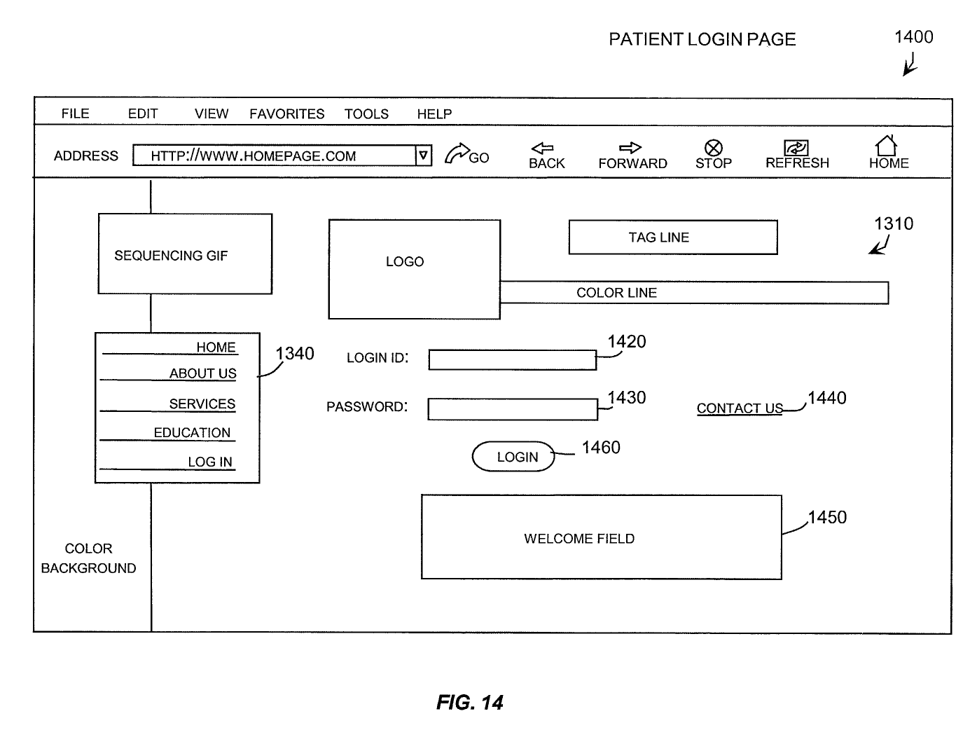

If data update is currently not to be performed, the No branch of step 950 is followed to step 920, in which the main integration update cycle is repeated. If an update is currently to be performed, the Yes branch of step 950 is followed to Routine 960, in which the data is transferred between the client integration unit 115 and the server integration unit 145. Routine 960 is described in greater detail in reference to FIG. 14.

Routine 960 is followed by step 970, in which the practice management system 175 is updated. After the session is terminated, the practice updates the records of the practice management system 175. A data viewer 280 can display the current data side by side with the existing data for each patient. The XML data is displayed using known Extensible Stylesheet Language (XSL) technology. The changes to the existing files can be manually keyed if the changes are acceptable. Alternatively, custom software can automatically implement the changes into the database upon acceptance.

Step 970 is followed by routine 980, in which the server integration unit 175 is updated. The provided XML files are stored in a directory associated with that practice management system 110. An XML parser and load the XML files and retrieve data stored in the XML files. After step 980, the process is returned to perform step 920, in which the main process is repeated.

Turning to FIG. 10, illustrated is a routine 910 executed in response to a web site creation request. In step 1010, the web system 120 receives a creation web site creation request. A web site system 120 hosts a known manner a world wide web site. The practice system 175 initiates a session with web site system 120. Those skilled in the art understand that a Web session typically occurs when an Internet browser computer program such as MICROSOFT INTERNET EXPLORER or NETSCAPE NAVIGATOR requests a web page from a server. The server responds by sending the requested Web page data in packets typically utilizing a transfer protocol known as the Transmission Control Protocol/Internet Protocol (TCP/IP). Typically, the web server application can be operable to pass a web request to an application program utilizing the known common gateway interface (CGI) or an Internet Sever Application Interface (ISAPI).

Step 1010 is followed by step 1020, in which the web system 120 authenticates the practice system 110. The practice system 110 is authenticated by the provision in a known manner of a username and associated password. If the practice system is not authenticated, the process is returned to perform step 920 of FIG. 9. If the practice system 110 is authenticated, step 1020 is followed by step 1030. A custom application program steps the user through the creation process by the utilization of a custom wizard routine.

In step 1030, the practice system can choose from a plethora of previously stored templates that provide the look and feel for the web site. The templates contain predefined content and declarations for displaying the content. The web site system 120 stores predefined text data and graphics data in XML documents. XSL stylesheets define the presentation of the data. The stylesheets may allow the user to choose various options for the presentation of data such as background color, color of selected regions, color and text size of captions, and other display options. Step 1030 is followed by step 1040, in which the site builder application 125 determines whether the practice system will provide custom content for the web site.

If custom content is provided, the Yes branch of step 1030 is followed to step 1050, in which the site builder application 125 receives the content. If custom content is not provided, the No branch of step 1030 is followed to step 1080, in which the site builder application 125 builds the back end integration for the other components of the web site integration system 100.

In step 1050, the site builder application 125 receives the custom content provided by the practice system 175. The practice system 110 can provide graphics and text which can substituted for the standardized content in a template. For example, the practice system 110 can provide graphics of the office personnel at the practice. The graphics can be provided in most standard graphic file formats such as Joint Photographic Experts Group (JPEG), Graphic Interchange Format (GIF), or Portable Network Graphics (PNG) formats. Additionally, the practice can provide text content such as biographies of the practitioners, special procedure instructions, or any other desired text.

Step 1050 is followed by step 1060, in which the site builder unit 125 stores the custom content. The custom content can be stored in a directory associated with that particular practice system 110. Step 1060 is followed by 1070, in which the site builder application 125 merges the stylesheet. The templates associate the custom content with the display declarations utilizing the known markups available with Extensible Stylesheet Language (XSL).

Step 1070 is followed by step 1080, in which the site builder unit 125 creates the back end integration. The back end integration is built automatically and is transparent to the practice system 110. The web site is created in a manner such that any data provided in stored in XML based files. The XML files are stored in a repository 150 associated with the host integration server 140. These files can be accessed by the other components of the web site integration system 100.

Turning to FIG. 11, illustrated is a routine 925 executed in response to a web site update request. In step 1110, the web system 120 receives an update request. As discussed in reference to FIG. 11, a web site system 120 hosts a known manner a world wide web site. The practice system 175 initiates a session with web site system 120. Those skilled in the art understand that a Web session typically occurs when an Internet browser computer program such as MICROSOFT INTERNET EXPLORER or NETSCAPE NAVIGATOR requests a web page from a server. The server responds by sending the requested Web page data in packets typically utilizing a transfer protocol known as the Transmission Control Protocol/Internet Protocol (TCP/IP). Typically, the web server application can be operable to pass a web request to an application program utilizing the known common gateway interface (CGI) or an Internet Sever Application Interface (ISAPI).

Step 1110 is followed by step 1120, in which the web system 120 authenticates the practice system 110. The practice system 110 is authenticated by the provision in a known manner of a username and associated password. If the practice system is not authenticated, the process is returned to perform step 930 of FIG. 9. If the practice system 110 is authenticated, step 1120 is followed by step 1130. A custom application steps the user through the update process.

In step 1130, web site system 120 receives the custom content update provided by the practice system 175. The practice system 110 can provide graphics and text which can substituted for content previously provided. For example, the practice system 110 can provide graphics of new office personnel at the practice. The graphics can be provided in most standard graphic file formats such as JPEG or TIFF formats. Additionally, the practice can provide text content such as updated biographies of the practitioners, special procedure instructions, or any other desired text.

Step 11130 is followed by step 11140, in which the web site system 120 stores the custom content. The custom content can be stored in a directory associated with that practice system 110. Step 1140 is followed by 1150, in which the web site system 120 merges the stylesheet. The templates associate the custom content with the display declarations utilizing the known markups available with Extensible Stylesheet Language (XSL). These files can be accessed to display the updated practice web site.

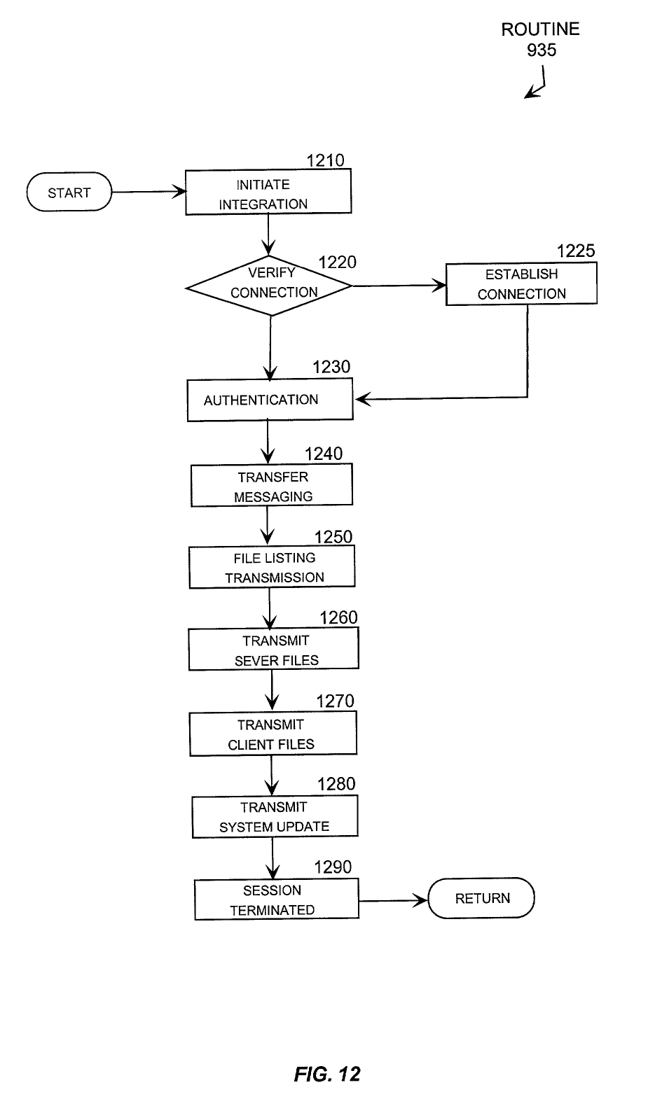

Turning to FIG. 12, illustrated is a routine 960 executed in response to a practice system 110 initiating the client integration unit 115 as illustrated by step1210. Step 1210 is followed by step 1220. In step 1220, the client integration detects the availability and state of Internet connectivity at the local machine. If an Internet connection is detected, step 1220 is followed by step 1230, in which the client integration systems 110 logs into the server integration system 140. If an Internet connection is not detected, step 1220 is followed by step 1225, in which the client integration systems 110 dials, connects to the Internet 101, and establishes a connection with the server integration unit 145 using Secure Socket Layer (SSL) technology. The connection is made utilizing the known Hypertext Transfer Protocol over Secure Socket Layer (HTTPS) protocol. Step 1225 is followed by step 1230.

In step 1230, the client integration unit 115 sends authentication information to the server integration unit 145. The authentication information can include the user name, password, current client integration unit version, and a globally unique identifier (GUID). This information is used to create a session key that verifies authenticity of the client integration unit 115 and prevents multiple machines at any one practice from attempting to simultaneously transfer files to the integration server 140. Each time a client system 110 logs on to the integration server 140, the server integration unit 145 generates and transfers this session key. The session key remains valid for the duration of that particular session. The session key is used to uniquely identify each client system and session combination.

The login process encrypts the user identification and creates hash value for the session key. This encrypted hash value is transferred to the client system. In all subsequent communications, the client system 110 includes this session key in subsequent HTTPS headers that are transmitted. The server integration unit 145 will reject subsequent transmissions that do not include the appropriate session key in the HTTPS header. The application of encryption key technology—in addition to the security provided by SSL technology—dramatically reduces security vulnerability of the integration server 140.

Step 1230 is followed by step 1240, in which e-mail messaging and system messaging information is transmitted. The practice can design multiple web cards for messaging purposes. The multiple web cards use Hypertext Markup Language (HTML) messaging templates, which include predefined text and images to create in a known manner HTML emails. HTML utilizes tags to mark elements, such as text and graphics, in a document to indicate how a browser should display these elements and respond to user actions such as the activation of a link. These cards can be used for season greeting cards, birthday cards, appointment reminders, and other messaging functions.

The practice system 110 downloads a list of cards previously defined on the web site. The practice can specify a list of patients to associate with each defined card. This messaging request is provided to the integration server unit 145. Additionally, the messaging function 363 transmits system application errors, diagnosis data, and potential issues to the server integration unit 145. These system messages are routed to the support personnel at the practice system vendor. Step 1240 is followed by step 1250.

In step 1250, the client integration unit 115 retrieves a list of files that are available for this practice on the integration server 140. If available, the list retrieval function 364 also retrieves a list and location of newer version of the client integration software 115 or other components. Step 1250 is followed by step 1260.

In step 1260, the client integration unit 115 initiates a request and receives each file for the particular practice that is stored on the integration server 140 for downloading. Each file is individually downloaded in compressed form. The client integration unit 115 maintains a record of the files transfers that have been completed. If the session is unexpectedly terminated, the transfer can begin with the next file. Step 1260 is followed by step 1270.

In step 1270, the client integration unit 115 initiates transfer of files queued to be uploaded to the integration server 140. The practice management system 175 creates files to be uploaded to the integration server 140.

These files can be created or modified upon a triggering event. Various processes, events, and operator interactions trigger file creations or modifications at the practice management system 175. The practice management system 175 can initiate client integration application 115 on a per file mode or a batch mode, as desired. Instead of creating and storing a patient file for only those newly created or modified records, some practice management systems 175 simply create a patient file for each patient in the practice database 250. Therefore, the file transfer function 366 performs a checksum of each file to determine if that file has changed since the last transfer. The client integration unit 115 determines from is the calculated checksum those files that have changed data from the last time the file was encountered. The checksum values can be stored in a checksum database 359 on a storage device 350 associated with the workstation 260. If it is determined that the most current information is already exists on the integration server 140, the file is deleted from the outbox directory 351 and no file export for that file is performed. If the file has changed, the file is sent and the new checksum in stored in the checksum database 359. After transmitting the file, the file is deleted from the outbox directory 351. The file transfer function 367 deletes the files from the storage unit 350 in order to increase the security of the information and reduce storage requirements. Step 1270 is followed by step 1280.

In step 1280, the client integration unit 115 receives any new application component and initiates an auto-update operation to update to the current version of any component. Step 1280 is followed by step 1290, in which the client integration unit 115 logouts of the server integration unit 145 and disconnects any initiated Internet connections. After step 1290, the process is returned to perform routine 970 of FIG. 9.

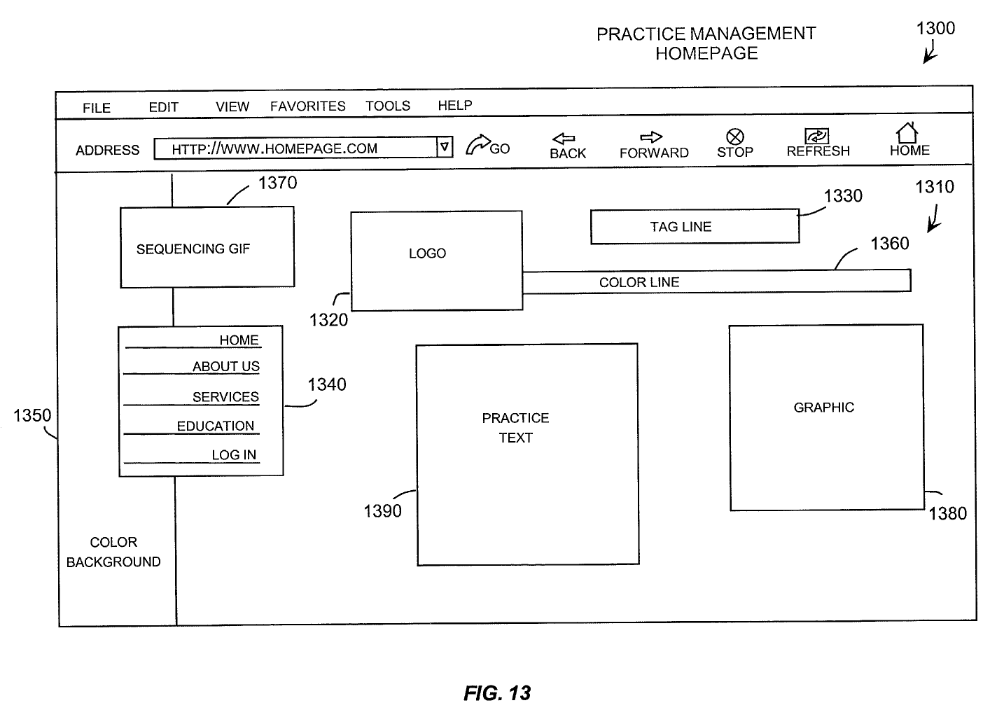

Turning to FIG. 13, illustrated is an exemplary screenshot of a practice management homepage 1300 that can be created by the site builder unit 145. A web page is a document that can be displayed in a known manner on the world wide web (WWW) and is identified by a unique Uniform Resource Locator (URL). A web browser is operable in a known manner to display a web page for the specified URL. As illustrated, the homepage can display various text and graphic elements. One skilled in the art will recognize that web pages can vary dramatically in content, display features, and arrangements.

The illustrated web page 1300 includes a uniform format section 1310 that encompasses a top and left border section. The illustrated uniform format section 1310 comprise a tag line field 1330, logo section 1330, color line 1360, a sequencing Graphical Interchange Format (GIF) display1370, a color background strip 1350, and a site locator section 1340. The illustrated uniform format section 1310 can stay constant throughout the web site to present a consistent look and feel to the displayed web site.

As shown, the logo section 1320 displays the practice logo or other graphical image provided by the practice. Stored templates have associated graphical images, such as a graphical images of smiling families for a dental practice, that can be used in place of a logo. A tag line field 1330 can display the practice slogan or other text. Likewise, the web page 1330 can display flashing or sequencing GIF images, which can help focus attention to important new information, retail sales, and the like. A site locator section 1340 can include selectable link fields that can display the associated web page desired by the user.

A color line 1360 can visually separate the uniform section 1310 with function material on each selected web page of the web site. Clearly, the hue and color can be custom selected. Likewise, a color background strip 1350 can be specified to create a look desired by a practice.

In addition, a practice text field 1380 can provide custom information about the practice. Clearly, standard text associated with the particular industry can be display or other information. Furthermore, graphic section 1390 can display any desired graphic including graphic images of the practitioners.

Turning to FIG. 14, illustrated is a screen shot of an exemplary login web 1400. As illustrated, user activation of a login selectable field 1445 in the site locator section 1340 will cause the user's browser to display the login web page 1400.

The web page 1400 can include a uniform format section 1310, which can stay constant throughout the web site to present a consistent look and feel to the displayed web site. The page 1400 can include a contact us field 1440 that causes the user's web browser to display contact information. In addition, the page 1400 can display either graphics or text in a welcome field to further enhance the visual image of the web page 1400.

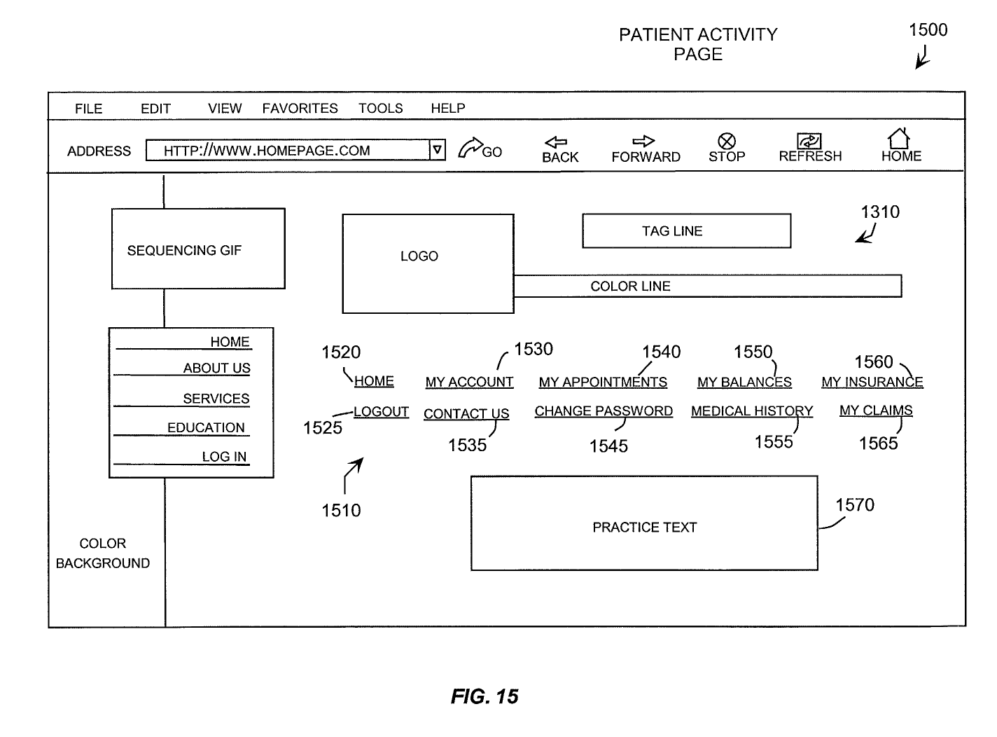

The login web page 1400 contains a login identification field 1420 and a password field. These fields accept user entered text. Upon activation of the login button 1460, the patient access unit 115 determines if the user has rights to gain access to patient information. If the user is authenticated, a main patient web page as shown in reference to FIG. 15 is displayed to the user.

Turning to FIG. 15, illustrated is a screen shot of an exemplary main patient web 1500. The web page is displayed to a user upon activation of the log in button referenced in FIG. 14 and patient authentication by the patient access unit 135.

The patient main web page 1500 can include a uniform format section 1310, which can stay constant throughout the web site to present a consistent look and feel to the displayed web site. The page 1500 can include a practice field 1570 that causes the user's web browser to display additional practice information or graphic images.

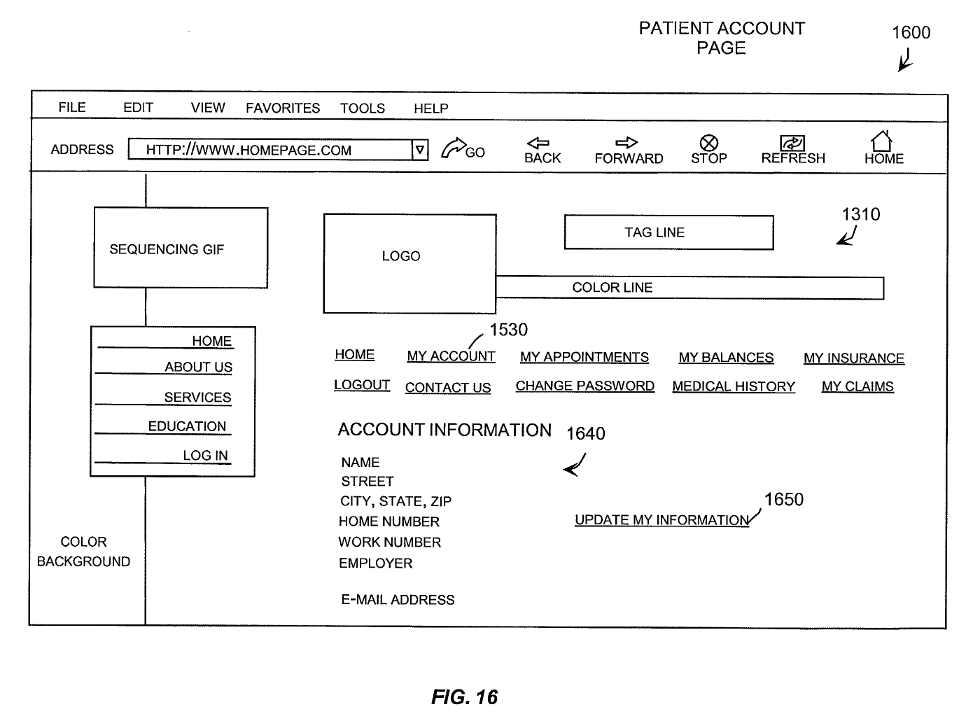

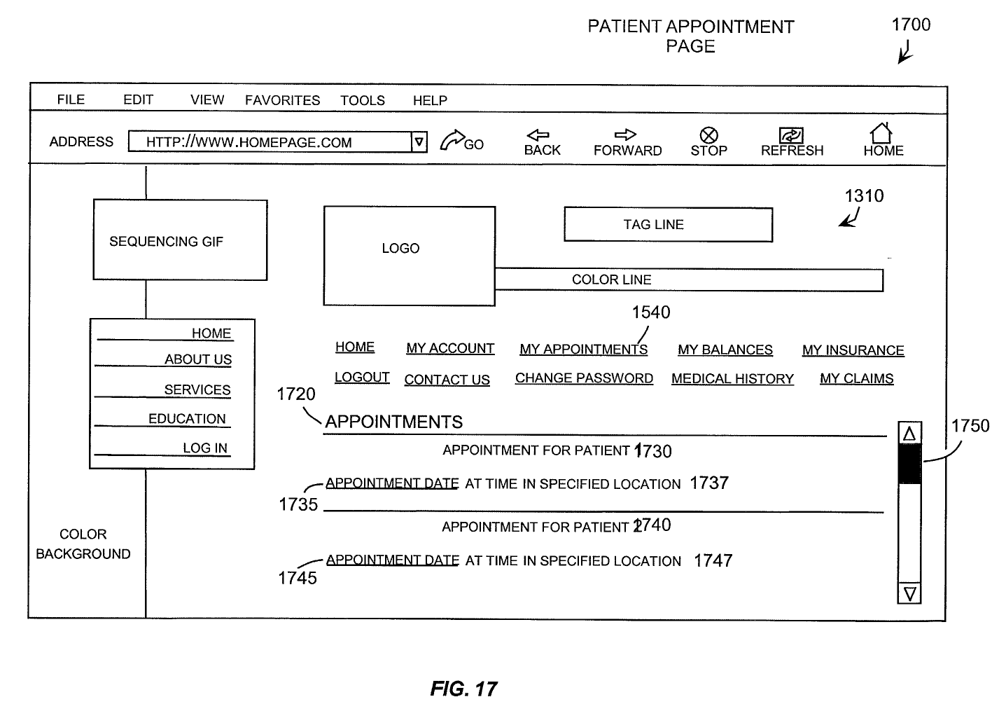

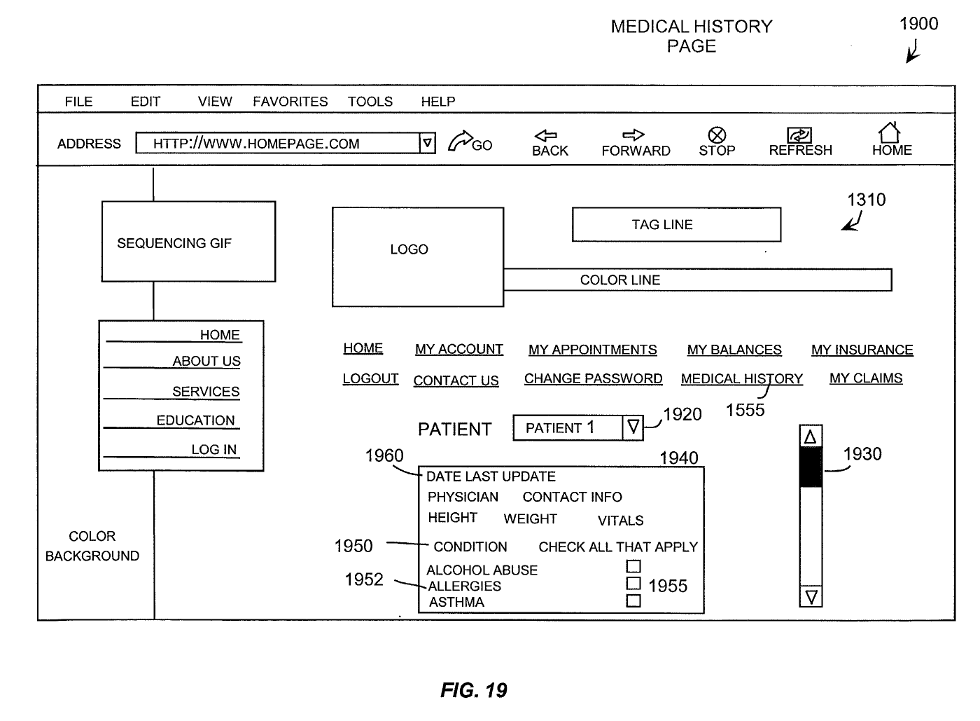

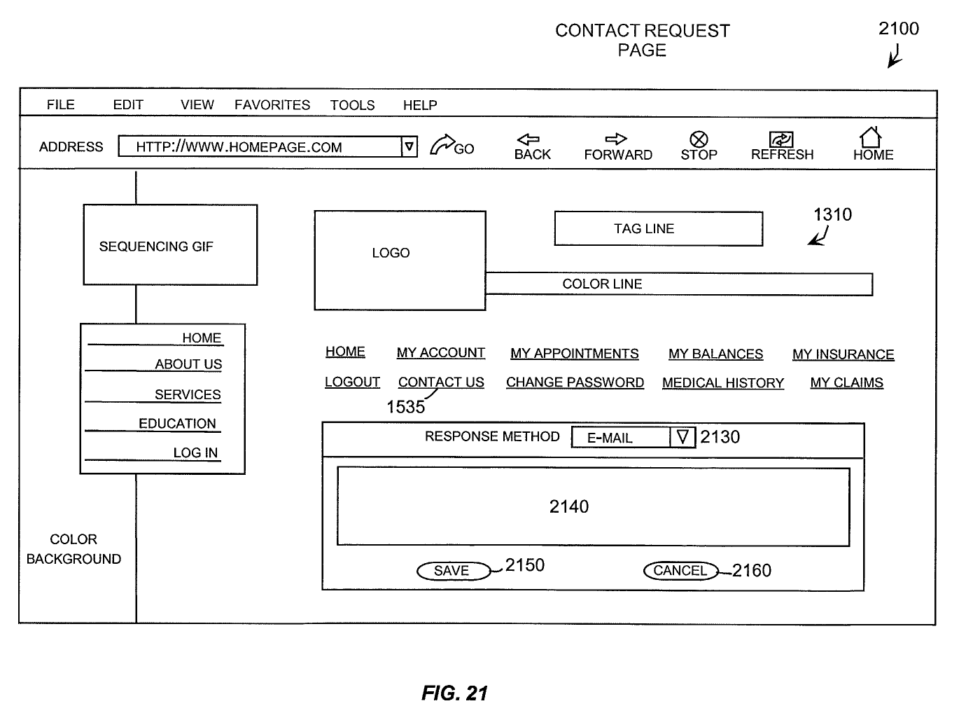

The patient main web page 1500 has patient access links 1510 that upon activation cause a display to the user of various web pages providing services offered by the web site system 140. These patient links 1510 can include a home link 1520 which sends the user to the practice home page 1300 as illustrated in reference to FIG. 13. The logout link 1525 logs the user out of the patient access unit 135 and a password link 1545 enables the user to change the access password. Additionally, an account link 1530 provides the user with a web page, as illustrated in FIG. 16, that displays and updates account information. In addition, a contact link 1535 provides the user with a web page, as illustrated in FIG. 21, that displays an electronic contact process. Moreover, a medical history link 1555 provides the user with a web page, as illustrated in FIG. 19, that displays and updates medical history information. An appointment link 1540 display an appointment web page as illustrated in reference to FIG. 17. Further links include a patient balance link 1550, a claims link 1565, and an insurance information link 1560. These links provide access to the associated information and, as previously discussed, a means to update the information.

Turning to FIG. 16, illustrated is a screen shot of an exemplary patient account web page 1600. The web page is displayed to a user upon activation of an account link 1530 referenced in FIG. 15. The patient account web page 1600 can include a uniform format section 1310, which can stay constant throughout the web site to present a consistent look and feel to the displayed web site.

The page 1600 displays to the user the patient account information 1640. This information can include display fields for contact data such as name, post address, e-mail address, current employer, and the like. In addition, the page 1600 can include an update information button 1650. Activation of the update button 1650 can cause the display another web page with text fields for input of new account information.

Turning to FIG. 17, illustrated is a screen shot of an exemplary patient appointment web page 1700. The web page is displayed to a user upon activation of an appointment link 1540 referenced in FIG. 15. The patient appointment web page 1700 can include a uniform format section 1310, which can stay constant throughout the web site to present a consistent look and feel to the displayed web site.

The page 1700 displays an appointment section 1720 that provides the schedules for the patients associated with the patients account. As illustrated, displayed is the patient 1 appointment information 1730, which includes displayed text line 1737 providing date and location information. Also illustrated is the patient 2 appointment information 1740, which includes a displayed text line 1747 providing date and location information. A scroll bar 1750 enables a user to scroll through the appointment section and display additional scheduled appointments.

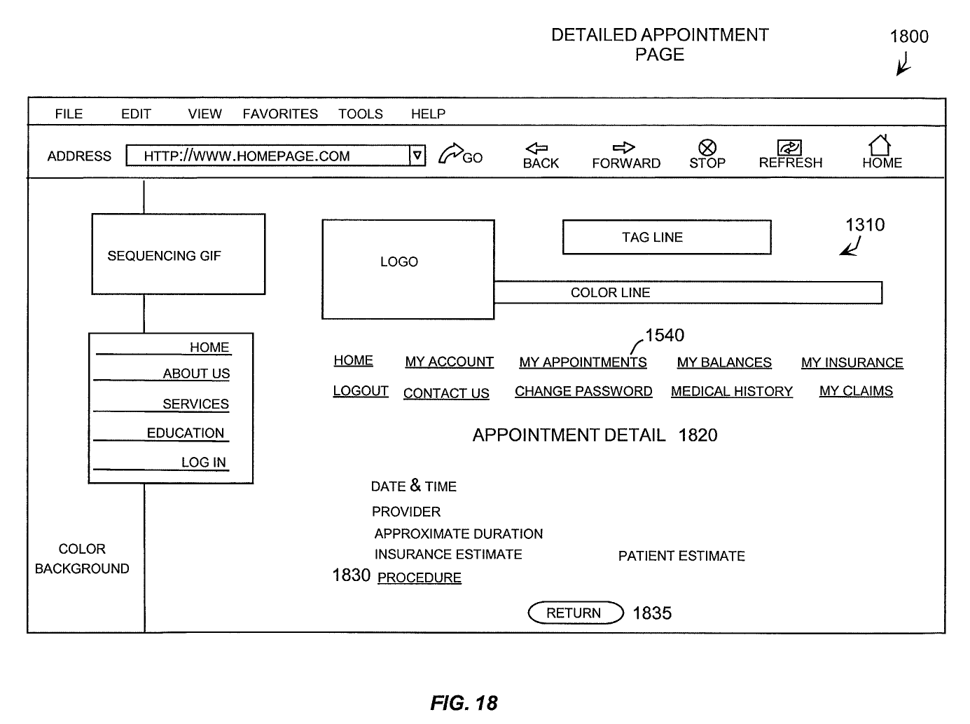

Each information line contains an appointment date button, 1735 and 1745, which cause the user's browser to display detailed appointment information as shown in reference to FIG. 18.

Turning to FIG. 18, illustrated is a screen shot of an exemplary detailed appointment web page 1800. The web page is displayed to a user upon activation of an appointment date button referenced in FIG. 17. The detailed appointment web page 1800 can include a uniform format section 1310, which can stay constant throughout the web site to present a consistent look and feel to the displayed web site.

The page 1800 displays a detailed appointment section 1820. As illustrated, this section 1820 provides information such as the date and time, the health care provider, the procedure, approximate duration, insurance coverage, and cost expected to be covered by the patient. A procedure button 1830 can be activated to cause the display of a web page that explains or provides additional information relating to the particular procedure. A return button 1835 causes the user's browser to display an appoint web page 1700 as referenced in FIG. 17.

Turning to FIG. 19, illustrated is a screen shot of an exemplary medical history web page 1900. The web page 1900 is displayed to a user upon activation of an medical history link 1555 referenced in FIG. 15. The medical history web page 1900 can include a uniform format section 1310, which can stay constant throughout the web site to present a consistent look and feel to the displayed web site.

The page 1900 includes a patient selector 1920 that scrolls through the patients associated with the patient account. As illustrated, patient 1 medical history has been selected. The medical history section 1940 display pre-selected text fields that can be scrolled through by the associated scroll bar 1930. The initial information in the medical history section 1940 is general medical information 1960 such as the update date, physician and the physician contact data, and the patient's height, weight, and blood pressure. Condition description fields 1950 list various relevant medical conditions and each condition has an associated check box. For example, the allergies condition field 1952 has a check box 1955 to specify that condition may apply to the patient. The scroll bar 1930 provides a means to scroll through a list of pre-selected medical conditions.

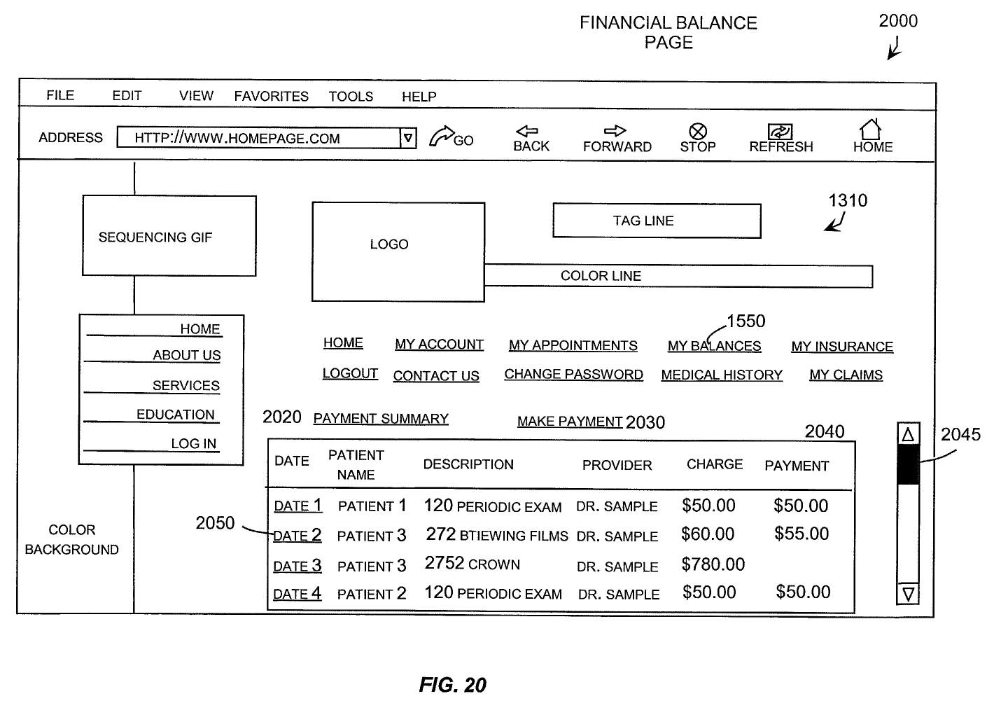

Turning to FIG. 20, illustrated is a screen shot of an exemplary patient balance web page 2000. The web page is displayed to a user upon activation of a balance link 1550 referenced in FIG. 15. The patient balance web page 2000 can include a uniform format section 1310, which can stay constant throughout the web site to present a consistent look and feel to the displayed web site.

The page 2000 displays a financial section 2040 that provides information relating patient charges. As illustrated, displayed is a chronological listing of patient charges including dates, patient names, descriptions, providers, charges, insurance payments, and other related information. The date field 2050 can be activated to provide another web page that display detailed information relating to the charge. A scroll bar 2045 enables a user to scroll up or down the charge listing to view additional information. In addition, activation of a payment summary button 2020 causes the display of another web page that provides current balance and year-to-date summary information. Likewise, activation of a make payment button 2030 causes the display of another web page that has input fields for accepting payment data such as payment amounts and credit card or bank account withdrawal information.

Turning to FIG. 21, illustrated is a screen shot of an exemplary contact web page 2100. The web page 2100 is displayed to a user upon activation of a contact link 1535 referenced in FIG. 15. The patient contact web page 2100 can include a uniform format section 1310, which can stay constant throughout the web site to present a consistent look and feel to the displayed web site. The page 2100 displays a text input field 2140 for text messages. A cancel button 2160 clears any typed text in the text field 2140. A selector 2130 enables a user to select the contact method. As illustrated, the message will be sent via e-mail. If the user activates the save button 2150, the message is saved to a storage unit 150. As previously discussed, the patient access unit 115 can process saved messages and provide messages to the particular practice system 110.

In view of the foregoing, it will be appreciated that the invention provides for two-way integration of web data with a practice management system. It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustration, which are intended to define the exclusive rights of the invention.

The invention claimed is:

1. A method of integrating data, comprising the steps of:
building, on a host system, a web site operable to receive input data;
transmitting the input data from the host system to a remote computer system;
receiving display data from the remote computer system;
storing the display data on a host storage device associated with the host computer system;
retrieving requested display data upon receiving a display data request; and
displaying the requested display data on the web site.

2. The method of claim 1, further comprising:
updating primary record data at the remote computer system based upon the input data;

3. The method of claim 1, wherein the input data includes character data stored in connection with metadata to create elements of a markup language.

4. The method of claim 1, wherein the display data includes character data stored in connection with metadata to create elements of a markup language.

5. The method of claim 1, further comprising the step of updating the web site based on update information supplied from the remote computer system.

6. A method of integrating data, comprising the steps of:
transmitting from remote computer to a host system web data;
building, on the host system, a web site that incorporates the web data, the web site operable to receive input data;
receiving the input data from the host system at a remote computer system;
updating primary record data at the remote computer system based upon the input data;
transmitting display data from the remote computer system to the host computer system, wherein requested display data is displayed on the web site.

7. The method of claim 6, wherein the input data includes character data stored in connection with tags to create elements of a markup language.

8. The method of claim 6, wherein the display data includes character data stored in connection with tags to create elements of a markup language.

9. The method of claim 6, further comprising the step of transmitting updated web data to the host system, wherein the updated web data is incorporated into the web site

10. The method of claim 7, wherein the updated web data includes character data stored in connection with metadata to create elements of a markup language.

11. A method for integrating data, comprising the steps of:
building, at a host system, a plurality of web sites, each web site associated with a separate remote system;
receiving a plurality of display data from a plurality of remote systems;
storing the plurality of display data on a host storage device associated with the host system;
associating particular display data with a corresponding remote system that provided the particular display data;
upon a particular web site receiving a particular display request, displaying requested particular display data;
receiving particular input data in response to a display of the requested particular display data;
storing the particular input data in association with the particular remote system; and
transmitting the particular input data to the particular remote system;

12. The method of claim 11, further comprising the step of updating primary records at the particular remote system based upon the particular input data.

13. The method of claim 11, wherein the input data includes character data stored in connection with metadata to create elements of a markup language.

14. The method of claim 11, wherein the display data includes character data stored in connection with metadata to create elements of a markup language.

15. The method of claim 11, further comprising the step of transmitting particular updated web data to the host system, wherein the particular updated web data is incorporated into an associated particular web site

16. A system for integrating data, comprising:
a host system operable to create web sites;
the host system operable to receive display data over a network from remote systems;
a storage device associated with the host system operable to store the display data;
the web site operable to receive display data requests;
the host system operable to retrieve the display data;
the web site operable to display requested display data;
the web sites operable to receive input data;
a communication device associated with the host system to transmit over a network input data received from the web sites to remote systems;

17. The system of claim 16, further comprising:
the remote system operable to update primary record data based upon the input data.

18. The system of claim 1, wherein the input data includes character data stored in connection with metadata to create elements of a markup language.

19. The system of claim 1, wherein the display data includes character data stored in connection with metadata to create elements of a markup language.

20. The system of claim 1, further comprising the host system operable to update the web sites based on update information supplied from the remote systems.

21. A system of integrating data, comprising:
a remote system operable to transmit to a host system display data;
the remote system operable to access over a network an application module that creates web sites, the web sites operable to display the display data;
the remote system operable to receive from the host system input data received by the web sites;
the remote system operable to update primary record data based upon the input data;

22. The system of claim 21, wherein the input data includes character data stored in connection with metadata to create elements of a markup language.

23. The system of claim 21, wherein the display data includes character data stored in connection with metadata to create elements of a markup language.

24. The system of claim 21, further comprising the remote system operable to transmit updated web data to the host system, wherein the updated web data is incorporated into the web site.

25. A method of integrating data into a practice management system, comprising the steps of:
receiving, at a host system; patient information files from the practice management system;
receiving patient input data from a web site;
storing, at the host system, the patient input data; and
transmitting the patient input data from the host system to the practice management system.

26. The method of claim 25, further comprising the steps of:
displaying the patient input data in conjunction with original patient information; and
integrating accepted patient input data in the practice management system,

27. The method of claim 25, further comprising the steps of:
building a web site operable to display requested patient information; and
displaying the requested patient information based upon the patient information files.

28. A system of integrating data into a practice management system, comprising:
a host system operable to receive patient information files from the practice management system;
a web site operable to receive patient input data and to display requested patient information based upon the patient information files;
a storage device coupled to the host system operable to store the patient input data; and
a communication device coupled to the host system operable to transmit the patient input data to the practice management system.

29. A method of integrating data into a practice management system, comprising the steps of:
receiving, at a host system; login data from the practice management system to initiate a session;
transmitting to the practice management system a session key for continuing communications associated with the session;
receiving, during the session, patient account information from the practice management system to generate patient access authorization;
upon receiving the patient access authorization, requesting patient access authorization change information, wherein the practice management system does not have access to the patient access change information.

30. The method of claim 29, further comprising the steps of:
receiving, during the session, patient information files from the practice management system;
receiving patient input data from a web site;
storing, at the host system, the patient input data; and
transmitting the patient input data from the host system to the practice management system.
